(19) United States
(12) Patent Application Publication
(10) Pub. No.: US 2006/0238654 A1
(43) Pub. Date: Oct. 26, 2006

(54) Image data processing apparatus

(75) Inventor: Sadafumi Kanada, Ibaraki-ken (JP)

Correspondence Address: LOUIS WOO;LAW OFFICE OF LOUIS WOO, 717 NORTH FAYETTE STREET, ALEXANDRIA, VA, 22314, US

(73) Assignee: Victor Company of Japan, Ltd., Yokohama (JP)

(21) Appl. No.: 11/376,119

(22) Filed: Mar. 16, 2006

(30) Foreign Application Priority Data
Apr. 26, 2005 (JP) 2005-127518

(51) Int. Cl. H04N 5/44; H04N 9/74

(52) U.S. Cl. 348/581; 348/561; 345/682

(57) ABSTRACT

A first device decides whether or not a level of a first digital signal representative of an original picture changes discontinuously at a pixel of interest in a first elongated region. A second device generates a discontinuity condition signal representing a continuity-related condition of a discontinuity of the first digital signal in a second elongated region perpendicular to the first elongated region. First data representative of a linear interpolation coefficient is generated in response to a conversion magnification. Second data representative of a nonlinear-interpolation coefficient is generated in response to the conversion magnification and the discontinuity condition signal. The second data is selected when the signal level changes discontinuously. Otherwise, the first data is selected. The first digital signal is subjected to an interpolation-based filtering process responsive to the selected data to convert the first digital signal into a second digital signal representative of a conversion-result picture.

### BACKGROUND OF THE INVENTION

1. Field of the Invention

This invention relates to an apparatus for processing and converting first image data into second image data in accordance with a designated magnification. Furthermore, this invention relates to a method of processing and converting first image data into second image data in accordance with a designated magnification. A frame represented by the first image data is composed of a first predetermined number of pixels while a frame represented by the second image data is composed of a second predetermined number of pixels which differs from the first predetermined number. Therefore, the conversion of the first image data into the second image data involves a change in the resolution of a represented 1-frame picture.

2. Description of the Related Art

In the case where the number of pixels forming one frame represented by first image data differs from the number of pixel-corresponding segments constituting the screen of a display, the first image data is required to be converted into second image data representing a frame composed of a number of pixels which is equal to the number of pixel-corresponding segments of the display screen. The conversion of the first image data into the second image data involves conversion of the resolution of a represented 1-frame picture. It is known to utilize linear interpolation for such picture resolution conversion.

Known image data processing apparatuses utilizing linear interpolation procedures for picture resolution conversion tend to cause an insufficient quality of a conversion-result picture when an original picture is in a particular condition. For example, the signal waveform representing an edge of an isolated area or stripe in an original picture is dulled by the linear interpolation procedure so that a conversion-result picture will have an obscure portion. In the case of an original picture having white dots or stripes (white isolated points) on a black background, the luminance at each of the isolated points is reduced by the linear interpolation procedure so that the quality of a conversion-result picture will drop.

Japanese patent application publication number P2001-274987A discloses an image data processing apparatus including a resolution conversion circuit which utilizes linear interpolation to convert a sequence of original pixel-corresponding data pieces into a sequence of interpolation-result pixel-corresponding data pieces at a picture reduction factor of 4/5. The apparatus of Japanese application P2001-274987A further includes a waveform monitor circuit and a data correction circuit. The waveform monitor circuit observes a predetermined number of successive original pixel-corresponding data pieces, which are periodically updated, to detect every local signal-level maximum and every local signal-level minimum represented by the sequence of the original pixel-corresponding data pieces. The waveform monitor circuit informs the data correction circuit of the detected local signal-level maximums and minimums. The data correction circuit receives the sequence of interpolation-result pixel-corresponding data pieces from the resolution conversion circuit. When an interpolation-result pixel-corresponding data piece of interest corresponds to a detected local signal-level maximum or minimum, the data correction circuit outputs a conversion-result pixel-corresponding data piece assigned the detected local signal-level maximum or minimum. Otherwise, the data correction circuit passes the interpolation-result pixel-corresponding data piece of interest as a conversion-result pixel-corresponding data piece.

Generally, ends of a fixed-luminance line segment in a picture correspond to one-step signal-level changes rather than local signal-level extrema (a maximum and a minimum) represented by a sequence of pixel-corresponding data pieces arranged in an order accorded with a direction parallel to the fixed-luminance line segment. Therefore, the waveform monitor circuit in the apparatus of Japanese application P2001-274987A can not sense ends of a fixed-luminance line segment in an original picture which extends along a scanning direction. Thus, for such line segment ends, the data correction circuit in the apparatus of Japanese application P2001-274987A passes the interpolation-result pixel-corresponding data piece of interest as a conversion-result pixel-corresponding data piece. Therefore, ends of a corresponding line segment in a conversion-result picture tend to be dulled relative to those in the original picture.

Generally, a fixed-luminance wide region in a picture is composed of fixed-luminance line segments. Edges of the fixed-luminance wide region is formed by ends of the fixed-luminance line segments. As mentioned above, the apparatus of Japanese application P2001-274987A tends to cause dulled ends of each line segment in a conversion-result picture which corresponds to one of the fixed-luminance line segments in the original picture. The dulled ends of the line segments result in dulled edges of a region in the conversion-result picture which corresponds to the fixed-luminance wide region in the original picture.

### SUMMARY OF THE INVENTION

It is an object of this invention to provide an apparatus for processing image data which can prevent not only isolated points but also edges of a fixed-luminance region (including a fixed-luminance line segment) in a processing-result picture from being dulled.

It is another object of this invention to provide an improved method of processing image data.

A first aspect of this invention provides an image data processing apparatus comprising first means for monitoring a level of a first digital signal representative of an original picture in a first prescribed region having a first predetermined number of pixels arranged along a first direction, and deciding whether or not the monitored level changes discontinuously at a pixel of interest in the first prescribed region; second means for monitoring a discontinuity of the first digital signal representative of the original picture in a second prescribed region having a second predetermined number of pixels arranged along a second direction perpendicular to the first direction, and generating a discontinuity condition signal representing a continuity-related condition of the monitored discontinuity; third means for generating first data representative of a linear interpolation coefficient in response to a conversion magnification; fourth means for generating second data representative of a nonlinear-interpolation coefficient in response to the conversion magnification and the discontinuity condition signal generated by the second means; fifth means for selecting the first data generated by the third means as selection-result data when the first means decides that the monitored level does not change discontinuously at the pixel of interest, and selecting the second data generated by the fourth means as the selection-result data when the first means decides that the monitored level changes discontinuously at the pixel of interest; and sixth means for subjecting the first digital signal to an interpolation-based filtering process responsive to the selection-result data generated by the fifth means to convert the first digital signal into a second digital signal representative of a conversion-result picture.

A second aspect of this invention is based on the first aspect thereof, and provides an image data processing apparatus wherein the fourth means and the fifth means comprise means for using the level of the first digital signal at the pixel of interest as a level of the second digital signal at a pixel in a setting range containing a time point corresponding to the pixel of interest when the first means decides that the monitored level changes discontinuously at the pixel of interest, and means for increasing the setting range as the conversion magnification decreases in cases where the conversion magnification corresponds to picture reducing conversion.

A third aspect of this invention is based on the first aspect thereof, and provides an image data processing apparatus wherein the fourth means and the fifth means comprise means for using the level of the first digital signal at the pixel of interest as a level of the second digital signal at a pixel in a setting range containing a time point corresponding to the pixel of interest when the first means decides that the monitored level changes discontinuously at the pixel of interest, and means for increasing the setting range as the conversion magnification increases in cases where the conversion magnification corresponds to picture enlarging conversion.

A fourth aspect of this invention provides an image data processing method comprising the steps of monitoring a level of a first digital signal representative of an original picture in a first prescribed region having a first predetermined number of pixels arranged along a first direction, and deciding whether or not the monitored level changes discontinuously at a pixel of interest in the first prescribed region; monitoring a discontinuity of the first digital signal representative of the original picture in a second prescribed region having a second predetermined number of pixels arranged along a second direction perpendicular to the first direction, and generating a discontinuity condition signal representing a continuity-related condition of the monitored discontinuity; generating first data representative of a linear interpolation coefficient in response to a conversion magnification; generating second data representative of a nonlinear-interpolation coefficient in response to the conversion magnification and the discontinuity condition signal; selecting the first data as selection-result data when it is decided that the monitored level does not change discontinuously at the pixel of interest, and selecting the second data as the selection-result data when it is decided that the monitored level changes discontinuously at the pixel of interest; and subjecting the first digital signal to an interpolation-based filtering process responsive to the selection-result data to convert the first digital signal into a second digital signal representative of a conversion-result picture.

This invention has the following advantages. The second data representative of the nonlinear-interpolation coefficient is generated in response to the discontinuity condition signal. This design makes it possible to prevent not only isolated points but also edges of a fixed-luminance region (including a fixed-luminance line segment) in a processing-result picture from being dulled. Therefore, a conversion-result picture closer to the original picture is available. The setting range is increased as the conversion magnification decreases in cases where the conversion magnification corresponds to picture reducing conversion. This design surely prevents the omission of an isolated point from the conversion-result picture. The setting range is increased as the conversion magnification increases in cases where the conversion magnification corresponds to picture enlarging conversion. This design makes it possible to prevent a luminance irregularity from occurring in the conversion-result picture.

### BRIEF DESCRIPTION OF THE DRAWINGS

FIG. 1 is a block diagram of an image data processing apparatus according to an embodiment of this invention.

FIG. 2 is a block diagram of a waveform monitor in FIG. 1.

FIG. 3 is a time-domain diagram of a first example of a change in level represented by an input digital signal, and a change in state of a property signal in the apparatus of FIG. 1.

FIG. 4 is a time-domain diagram of a second example of a change in level represented by the input digital signal, and a change in state of the property signal in the apparatus of FIG. 1.

FIG. 5 is a time-domain diagram of a third example of a change in level represented by the input digital signal, and a change in state of the property signal in the apparatus of FIG. 1.

FIG. 6 is a diagram showing an array of pixels constituting a portion of an original picture having a black letter “H” on a white background.

FIG. 7 is a time-domain diagram showing a first example of the waveforms of signals inputted to and outputted from a discontinuity monitor circuit in FIG. 1.

FIG. 8 is a time-domain diagram showing a second example of the waveforms of the signals inputted to and outputted from the discontinuity monitor circuit in FIG. 1.

FIG. 9 is a time-domain diagram showing a third example of the waveforms of the signals inputted to and outputted from the discontinuity monitor circuit in FIG. 1.

FIG. 10 is a time-domain diagram showing a fourth example of the waveforms of the signals inputted to and outputted from the discontinuity monitor circuit in FIG. 1.

FIG. 11 is a time-domain diagram showing a fifth example of the waveforms of the signals inputted to and outputted from the discontinuity monitor circuit in FIG. 1.

FIG. 12 is a time-domain diagram showing a sixth example of the waveforms of the signals inputted to and outputted from the discontinuity monitor circuit in FIG. 1.

FIG. 13 is a time-domain diagram showing a seventh example of the waveforms of the signals inputted to and outputted from the discontinuity monitor circuit in FIG. 1.

FIG. 14 is a block diagram of a resolution conversion circuit in FIG. 1.

FIG. 15 is a time-domain diagram of picture reducing conversion of a sequence of original pixel-corresponding data pieces into a sequence of conversion-result pixel-corresponding data pieces, waveforms represented by sequences of conversion-result pixel-corresponding data pieces, a waveform of a property signal, and a state of a coefficient combination.

FIG. 16 is a diagram showing an array of pixels constituting a portion of an original picture having the left-hand half of a black letter “H” on a white background, the waveforms of a property signal which correspond to the horizontal rows of pixels therein, and nonlinear-interpolation ranges NR related with the high-level terms in the waveforms of the property signal.

FIG. 17 is a diagram showing an array of pixels constituting a portion of an original picture having a black letter “H” on a white background, and an array of pixels constituting a portion of a corresponding conversion-result picture.

FIG. 18 is a diagram showing an array of pixels constituting a portion of an original picture having a black letter “H” on a white background, and an array of pixels constituting a portion of a hypothetical corresponding conversion-result picture.

FIG. 19 is a time-domain diagram of picture enlarging conversion of a sequence of original pixel-corresponding data pieces into a sequence of conversion-result pixel-corresponding data pieces, waveforms represented by sequences of conversion-result pixel-corresponding data pieces, a waveform of a property signal, and a state of a coefficient combination.

FIG. 20 is a time-domain diagram of a sequence of original pixel-corresponding data pieces and sequences of conversion-result pixel-corresponding data pieces generated by picture reducing conversion with a magnification factor of 4/5 and at different interpolation phases.

FIG. 21 is a time-domain diagram of a sequence of original pixel-corresponding data pieces and sequences of conversion-result pixel-corresponding data pieces generated by picture reducing conversion with a magnification factor of 4/6 and at different interpolation phases.

FIG. 22 is a time-domain diagram of a sequence of original pixel-corresponding data pieces and sequences of conversion-result pixel-corresponding data pieces generated by picture reducing conversion with a magnification factor of 4/7 and at different interpolation phases.

FIG. 23 is a time-domain diagram of a sequence of original pixel-corresponding data pieces and sequences of conversion-result pixel-corresponding data pieces generated by picture enlarging conversion with a magnification factor of 5/4 and at different interpolation phases.

FIG. 24 is a time-domain diagram of a sequence of original pixel-corresponding data pieces and sequences of conversion-result pixel-corresponding data pieces generated by picture enlarging conversion with a magnification factor of 6/4 and at different interpolation phases.

FIG. 25 is a time-domain diagram of a sequence of original pixel-corresponding data pieces and sequences of conversion-result pixel-corresponding data pieces generated by picture enlarging conversion with a magnification factor of 7/4 and at different interpolation phases.

### DETAILED DESCRIPTION OF THE INVENTION

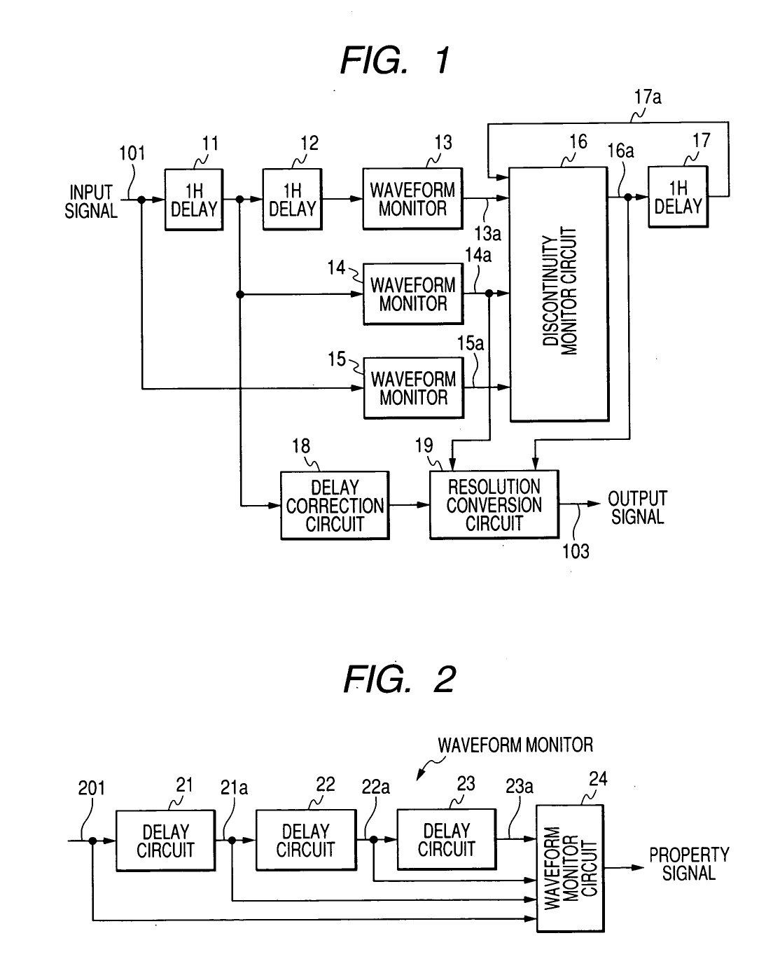

FIG. 1 shows an image data processing apparatus according to an embodiment of this invention. The apparatus of FIG. 1 includes 1H delay circuits 11, 12, and 17, waveform monitors 13, 14, and 15, a discontinuity monitor circuit 16, a delay correction circuit 18, and a resolution conversion circuit 19.

An input digital signal 101 representing an original picture is fed to the input sides of the 1H delay circuit 11 and the waveform monitor 15. The output side of the 1H delay circuit 11 is connected to the input sides of the 1H delay circuit 12, the waveform monitor 14, and the delay correction circuit 18. The output side of the 1H delay circuit 12 is connected to the input side of the waveform monitor 13. The output sides of the 1H delay circuits 13, 14, and 15 are connected to first, second, and third input terminals of the discontinuity monitor circuit 16. The output side of the 1H delay circuit 14 is also connected to a first input terminal of the resolution conversion circuit 19. The output terminal of the discontinuity monitor circuit 16 is connected to the input side of the 1H delay circuit 17 and a second input terminal of the resolution conversion circuit 19. The output side of the 1H delay circuit 17 is connected to a fourth input terminal of the discontinuity monitor circuit 16. The output side of the delay correction circuit 18 is connected to a third input terminal of the resolution conversion circuit 19. The resolution conversion circuit 19 outputs a digital signal 103 representing a conversion-result picture.

For example, the input digital signal 101 is of a line-by-line scanning format, and has a sequence of pixel-corresponding pieces. The 1H delay circuit 11 defers the input digital signal 101 by a time corresponding to one line (one horizontal scanning line) to get a first delayed signal. The 1H delay circuit 11 outputs the first delayed signal to the 1H delay circuit 12, the waveform monitor 14, and the delay correction circuit 18. The 1H delay circuit 12 defers the first delayed signal by a time corresponding to one line to get a second delayed signal. The 1H delay circuit 12 outputs the second delayed signal to the waveform monitor 13.

The waveform monitor 13 observes luminance levels or signal levels at pixel positions in a region which is covered by a prescribed number of neighboring pixels arranged along the horizontal scanning direction and represented by the output signal of the 1H delay circuit 12. The foregoing neighboring pixels are periodically updated. Basically, the waveform monitor 13 detects a waveform of the observed luminance levels (the observed signal levels) which has a variation greater than a predetermined threshold value. The waveform monitor 13 generates a property signal 13a depending on the detection of the waveform, and outputs the generated property signal 13a to the discontinuity monitor circuit 16.

The waveform monitor 14 observes luminance levels or signal levels at pixel positions in a region which is covered by the prescribed number of neighboring pixels arranged along the horizontal scanning direction and represented by the output signal of the 1H delay circuit 11. The foregoing neighboring pixels are periodically updated. Basically, the waveform monitor 14 detects a waveform of the observed luminance levels (the observed signal levels) which has a variation greater than the predetermined threshold value. The waveform monitor 14 generates a property signal 14a depending on the detection of the waveform, and outputs the generated property signal 14a to the discontinuity monitor circuit 16 and the resolution conversion circuit 19.

The waveform monitor 15 observes luminance levels or signal levels at pixel positions in a region which is covered by the prescribed number of neighboring pixels arranged along the horizontal scanning direction and represented by the input digital signal 101. The foregoing neighboring pixels are periodically updated. Basically, the waveform monitor 15 detects a waveform of the observed luminance levels (the observed signal levels) which has a variation greater than the predetermined threshold value. The waveform monitor 15 generates a property signal 15a depending on the detection of the waveform, and outputs the generated property signal 15a to the discontinuity monitor circuit 16.

The waveform monitors 13, 14, and 15 are of a same structure described below. With reference to FIG. 2, each of the waveform monitors 13, 14, and 15 includes delay circuits 21, 22, and 23, and a waveform monitor circuit 24. A digital signal 201 inputted to the waveform monitor is fed to the input side of the delay circuit 21 and a first input terminal of the waveform monitor circuit 24. The output side of the delay circuit 21 is connected to the input side of the delay circuit 22 and a second input terminal of the waveform monitor circuit 24. The output side of the delay circuit 22 is connected to the input side of the delay circuit 23 and a third input terminal of the waveform monitor circuit 24. The output side of the delay circuit 23 is connected to a fourth input terminal of the waveform monitor circuit 24. The waveform monitor circuit 24 has an output terminal leading to the discontinuity monitor circuit 16 (or the discontinuity monitor circuit 16 and the resolution conversion circuit 19).

The waveform monitor in FIG. 2 operates as follows. The delay circuit 21 defers the input digital signal 201 by a time corresponding to one pixel to get a first delayed signal 21a. The delay circuit 21 feeds the first delayed signal 21a to the delay circuit 22 and the waveform monitor circuit 24. The delay circuit 22 defers the first delayed signal 21a by a time corresponding to one pixel to get a second delayed signal 22a. The delay circuit 22 feeds the second delayed signal 22a to the delay circuit 23 and the waveform monitor circuit 24. The delay circuit 23 defers the second delayed signal 22a by a time corresponding to one pixel to get a third delayed signal 23a. The delay circuit 23 feeds the third delayed signal 23a to the waveform monitor circuit 24. The input digital signal 201, the first delayed signal 21a, the second delayed signal 22a, and the third delayed signal 23a fed to the waveform monitor circuit 24 represent four pixels which neighbor in the horizontal scanning direction, and which are periodically updated.

The waveform monitor circuit 24 observes luminance levels or signal levels at pixel positions in a region covered by the four periodically-updated neighboring pixels which are represented by the input digital signal 201, the first delayed signal 21a, the second delayed signal 22a, and the third delayed signal 23a. Specifically, the waveform monitor circuit 24 detects the levels (the luminance levels) represented by the signals 201, 21a, 22a, and 23a, that is, the signal levels at the four neighboring pixels arranged along the horizontal scanning direction.

The waveform monitor circuit 24 computes the difference between the detected levels represented by the input digital signal 201 and the first delayed signal 21a. This difference is referred to as the first difference. The waveform monitor circuit 24 calculates the absolute value of the first difference. The waveform monitor circuit 24 computes the difference between the detected levels represented by the first delayed signal 21a and the second delayed signal 22a. This difference is referred to as the second difference. The waveform monitor circuit 24 calculates the absolute value of the second difference. The waveform monitor circuit 24 computes the difference between the detected levels represented by the second delayed signal 22a and the third delayed signal 23a. This difference is referred to as the third difference. The waveform monitor circuit 24 calculates the absolute value of the third difference.

The waveform monitor circuit 24 compares the calculated absolute value of the first difference with a predetermined threshold value DLVL, and thereby decides whether or not the calculated absolute value of the first difference exceeds the predetermined threshold value DLVL. The waveform monitor circuit 24 compares the calculated absolute value of the second difference with the predetermined threshold value DLVL, and thereby decides whether or not the calculated absolute value of the second difference exceeds the predetermined threshold value DLVL. The waveform monitor circuit 24 compares the calculated absolute value of the third difference with the predetermined threshold value DLVL, and thereby decides whether or not the calculated absolute value of the third difference exceeds the predetermined threshold value DLVL.

The waveform monitor circuit 24 further decides whether or not at least one of the calculated absolute values of the first, second, and third differences exceeds the predetermined threshold value DLVL. When it is decided that at least one of the calculated absolute values of the first, second, and third differences exceeds the predetermined threshold value DLVL, the waveform monitor circuit 24 still further decides whether or not the boundary or boundaries of only one of the four neighboring pixels relate to the calculated absolute value or values exceeding the predetermined threshold value DLVL. When it is decided that the boundary or boundaries of only one of the four neighboring pixels relate to the calculated absolute value or values exceeding the predetermined threshold value DLVL, the waveform monitor circuit 13 concludes the monitored signal to be discontinuous concerning luminance level. In this case, the waveform monitor circuit 13 generates a property signal with a high level for the boundary or boundaries of the foregoing one of the four neighboring pixels and outputs the high-level property signal to the discontinuity monitor circuit 16 (or the discontinuity monitor circuit 16 and the resolution conversion circuit 19). In the other cases, the waveform monitor circuit 13 generates a property signal with a low level and outputs the low-level property signal to the discontinuity monitor circuit 16 (or the discontinuity monitor circuit 16 and the resolution conversion circuit 19).

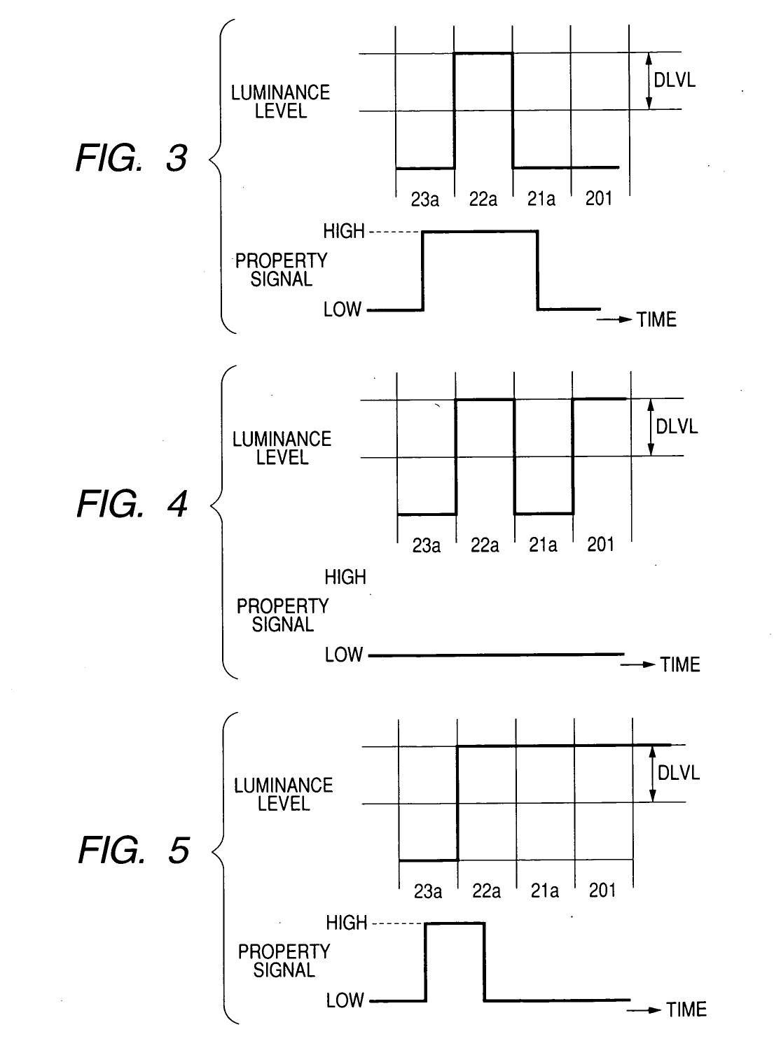

With reference to FIG. 3, in the case where the absolute values of the second and third differences exceed the predetermined threshold value DLVL while the absolute value of the first difference does not exceed the predetermined threshold value DLVL, the waveform monitor circuit 24 concludes that the luminance level represented by the input digital signal 201 is discontinuously changing at two positions in the observed region which correspond to the boundary between the pixels represented by the first and second delayed signals 21a and 22a and the boundary between the pixels represented by the second and third delayed signals 22a and 23a, and that the boundaries of only one of the four neighboring pixels in the observed region relate to the absolute values exceeding the predetermined threshold value DLVL. In this case, for the boundary between the pixels represented by the first and second delayed signals 21a and 22a and the boundary between the pixels represented by the second and third delayed signals 22a and 23a, the waveform monitor circuit 24 generates a property signal with a high level and outputs the high-level property signal to the discontinuity monitor circuit 16 (or the discontinuity monitor circuit 16 and the resolution conversion circuit 19). The time interval during which the property signal remains high in level is centered at a time point corresponding to the pixel represented by the second delayed signal 22a, and is equal in length to a 2-pixel term. In the conditions of FIG. 3, nonlinear interpolation is implemented during the time interval for which the property signal remains high in level.

With reference to FIG. 4, in the case where the absolute values of the first, second, and third differences exceed the predetermined threshold value DLVL, the waveform monitor circuit 24 concludes that the boundaries of at least two of the four neighboring pixels in the observed region relate to the absolute values exceeding the predetermined threshold value DLVL. In this case, the waveform monitor circuit 24 continuously generates a property signal with a low level and outputs the low-level property signal to the discontinuity monitor circuit 16 (or the discontinuity monitor circuit 16 and the resolution conversion circuit 19). In the conditions of FIG. 4, linear interpolation is implemented.

With reference to FIG. 5, in the case where the absolute value of the third difference exceeds the predetermined threshold value DLVL while the absolute values of the first and second differences do not exceed the predetermined threshold value DLVL, the waveform monitor circuit 24 concludes that the luminance level represented by the input digital signal 201 is discontinuously changing at a position in the observed region which corresponds to the boundary between the pixels represented by the second and third delayed signals 22a and 23a, and that the boundary of only one of the four neighboring pixels in the observed region relates to the absolute value exceeding the predetermined threshold value DLVL. In this case, for the boundary between the pixels represented by the second and third delayed signals 22a and 23a, the waveform monitor circuit 24 generates a property signal with a high level and outputs the high-level property signal to the discontinuity monitor circuit 16 (or the discontinuity monitor circuit 16 and the resolution conversion circuit 19). The time interval during which the property signal remains high in level is centered at a time point corresponding to the boundary between the pixels represented by the second and third delayed signals 22a and 23a, and is equal in length to a 1-pixel term. In the conditions of FIG. 5, nonlinear interpolation is implemented during the time interval for which the property signal remains high in level.

The waveform monitor circuit 24 uses, for example, a microcomputer or a similar device programmed to implement the previously-mentioned operation steps.

With reference back to FIG. 1, the discontinuity monitor circuit 16 receives the property signals 13a, 14a, and 15a from the waveform monitors 13, 14, and 15. The property signals 13a, 14a, and 15a correspond to three neighboring pixels arranged in a vertical direction with respect to a frame represented by the input video signal 101. The foregoing three neighboring pixels are periodically updated. By referring to the property signals 13a, 14a, and 15a, the discontinuity monitor circuit 16 observes a region covered by the three vertically-arranged neighboring pixels. The discontinuity monitor circuit 16 detects conditions (continuity-related conditions) of luminance-level discontinuity in the observed region, and generates a signal 16a depending on the detected discontinuity conditions. The discontinuity monitor circuit 16 outputs the discontinuity condition signal 16a to the 1H delay circuit 17 and the resolution conversion circuit 19.

The 1H delay circuit 17 defers the discontinuity condition signal 16a by a time corresponding to one line (one horizontal scanning line) to get a delayed discontinuity condition signal 17a. The 1H delay circuit 17 feeds the delayed discontinuity condition signal 17a back to the discontinuity monitor circuit 16. The discontinuity monitor circuit 16 decides the state of the discontinuity condition signal 16a in the light of the delayed discontinuity condition signal 17a.

Basically, the delay correction circuit 18 defers the output signal of the 1H delay circuit 11, and outputs the resultant digital signal to the resolution conversion circuit 19. Thus, the input digital signal 101 is propagated to the resolution conversion circuit 19 while being deferred by the delay correction circuit 18. The delay correction circuit 18 is designed to match the pixel-related timing of the application of the input digital signal 101 to the resolution conversion circuit 19 with the pixel-related timing of the application of the property signal 14a to the resolution conversion circuit 19 from the waveform monitor 14 and the pixel-related timing of the application of the discontinuity condition signal 16a to the resolution conversion circuit 19 from the discontinuity monitor circuit 16.

The discontinuity monitor circuit 16 operates as follows. The discontinuity monitor circuit 16 observes the states of the property signals 13a, 14a, and 15a. The discontinuity monitor circuit 16 decides whether or not a same discontinuity recurs for successive scanning lines as viewed along a vertical direction in an original picture on the basis of the observed states of the property signals 13a, 14a, and 15a. The discontinuity monitor circuit 16 regards the property signal 14a as an indication of a pixel of interest, and regards the property signals 13a and 15a as indications of pixels immediately above and below the pixel of interest. The discontinuity monitor circuit 16 determines the logic state of the discontinuity condition signal 16a for the pixel of interest in response to the results of the foregoing discontinuity-related decision. The discontinuity monitor circuit 16 considers the delayed discontinuity condition signal 17a in determining the logic state of the discontinuity condition signal 16a.

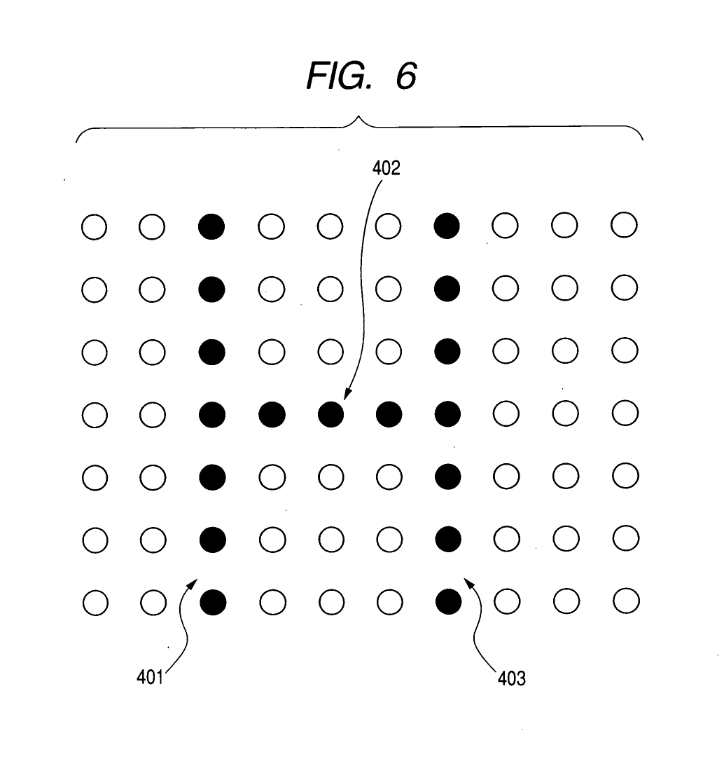

FIG. 6 shows an array of pixels constituting a portion of an original picture (a picture represented by the input digital signal 101) having a black letter “H” on a white background. In FIG. 6, black circles denote black pixels while white circles denote white pixels. The letter “H” is composed of a left-hand vertical line segment 401, a horizontal line segment 402, and a right-hand vertical line segment 403. The horizontal line segment 402 extends between the centers of the left-hand and right-hand vertical line segments 401 and 402. Each of the line segments 401, 402, and 403 has a sequence of black pixels.

FIG. 7 shows the states of the delayed discontinuity condition signal 17a, the property signals 13a, 14a, and 15a, and the discontinuity condition signal 16a which correspond to the left-hand vertical line segment 401 or the right-hand vertical line segment 403 of the letter “H” (see FIG. 6). In FIG. 7, the property signals 13a, 14a, and 15a assume the high level at the same timing and for the same time interval (the 2-pixel term). Thus, the discontinuity monitor circuit 16 decides that a same discontinuity recurs for successive scanning lines as viewed along a vertical direction in the original picture. In this case, the discontinuity monitor circuit 16 holds the discontinuity condition signal 16a at the low level.

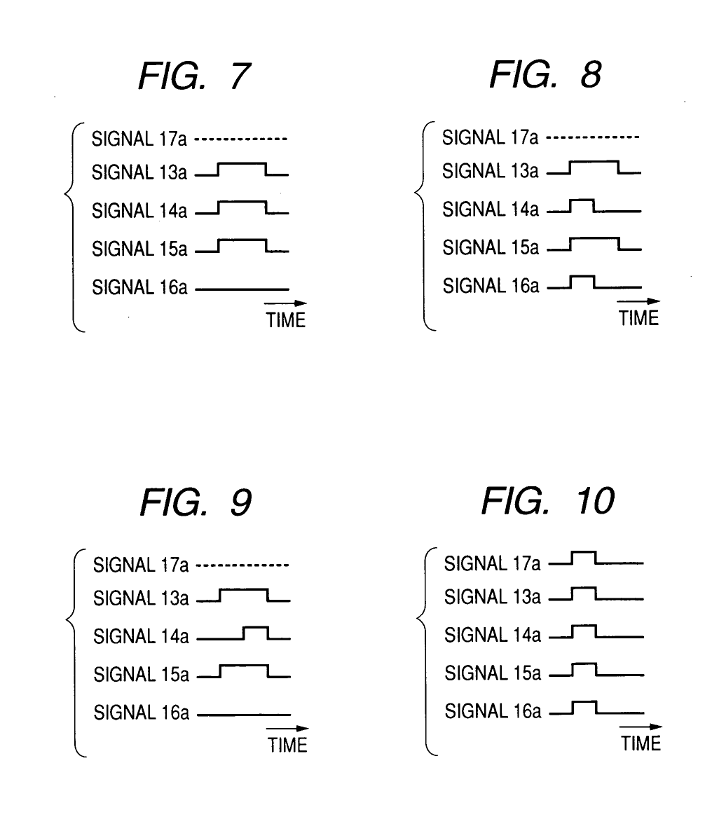

FIG. 8 shows the states of the delayed discontinuity condition signal 17a, the property signals 13a, 14a, and 15a, and the discontinuity condition signal 16a which correspond to a picture portion including the connection between the left-hand vertical line segment 401 and the horizontal line segment 402 of the letter “H” (see FIG. 6). In FIG. 8, the property signals 13a, 14a, and 15a change to the high level at the same timing, and the property signals 13a and 15a remain high in level for the longer time interval (the 2-pixel term) while the property signal 14a remains high in level for the shorter time interval (the 1-pixel term). Thus, the discontinuity monitor circuit 16 decides that a same discontinuity does not recur but different discontinuities occur at the same timing for successive scanning lines as viewed along a vertical direction in the original picture. In this case, the discontinuity monitor circuit 16 changes the discontinuity condition signal 16a to the high level at a timing equivalent to that of the property signal 14a, and then holds the discontinuity condition signal 16a at the high level for the 1-pixel term. As will be made clear later, the high-level discontinuity condition signal 16a causes the luminance level at the original-picture pixel on the connection between the left-hand vertical line segment 401 and the horizontal line segment 402 to be selected for the luminance level at a conversion-result-picture pixel located immediately leftward of the foregoing original-picture pixel.

FIG. 9 shows the states of the delayed discontinuity condition signal 17a, the property signals 13a, 14a, and 15a, and the discontinuity condition signal 16a which correspond to a picture portion including the connection between the right-hand vertical line segment 403 and the horizontal line segment 402 of the letter “H” (see FIG. 6). In FIG. 9, the property signals 13a and 15a change to the high level at a first timing, and the property signal 14a changes to the high level at a second timing later than the first timing. The property signals 13a and 15a remain high in level for the longer time interval (the 2-pixel term) while the property signal 14a remains high in level for the shorter time interval (the 1-pixel term). Thus, the discontinuity monitor circuit 16 decides that a same discontinuity does not recur but different discontinuities occur at different timings for successive scanning lines as viewed along a vertical direction in the original picture. In this case, the discontinuity monitor circuit 16 holds the discontinuity condition signal 16a at the low level. As will be made clear later, the low-level discontinuity condition signal 16a causes the luminance level at the original-picture pixel on the connection between the right-hand vertical line segment 403 and the horizontal line segment 402 to be selected for the luminance level at a conversion-result-picture pixel located immediately leftward of the foregoing original-picture pixel. This pixel selection is provided by default settings.

FIG. 10 shows the states of the delayed discontinuity condition signal 17a, the property signals 13a, 14a, and 15a, and the discontinuity condition signal 16a which correspond to a first vertical edge in the original picture. In FIG. 10, the property signals 13a, 14a, and 15a assume the high level at the same timing and for the same time interval (the 1-pixel term). Thus, the discontinuity monitor circuit 16 decides that a same discontinuity recurs for successive scanning lines as viewed along a vertical direction in the original picture. In this case, the discontinuity monitor circuit 16 holds the discontinuity condition signal 16a equal in state to the delayed discontinuity condition signal 17a. In FIG. 10, the delayed discontinuity condition signal 17a assumes the high level at a timing equivalent to that of the property signal 14a, and then remains high in level for the 1-pixel term. Thus, the discontinuity monitor circuit 16 changes the discontinuity condition signal 16a to the high level at a timing equivalent to that of the property signal 14a, and then holds the discontinuity condition signal 16a at the high level for the 1-pixel term.

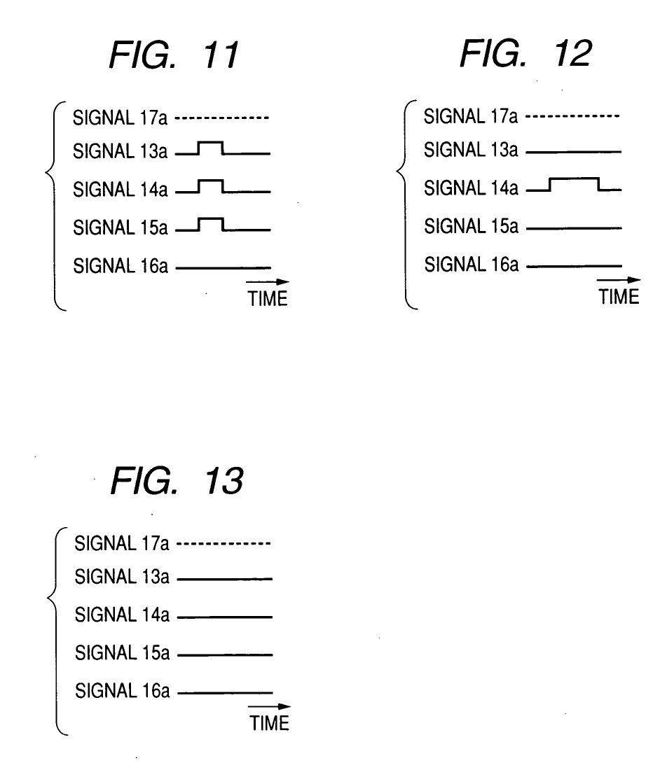

FIG. 11 shows the states of the delayed discontinuity condition signal 17a, the property signals 13a, 14a, and 15a, and the discontinuity condition signal 16a which correspond to a second vertical edge in the original picture. In FIG. 11, the property signals 13a, 14a, and 15a assume the high level at the same timing and for the same time interval (the 1-pixel term). Thus, the discontinuity monitor circuit 16 decides that a same discontinuity recurs for successive scanning lines as viewed along a vertical direction in the original picture. In this case, the discontinuity monitor circuit 16 holds the discontinuity condition signal 16a equal in state to the delayed discontinuity condition signal 17a. In FIG. 11, the delayed discontinuity condition signal 17a continues to assume the low level. Thus, the discontinuity monitor circuit 16 holds the discontinuity condition signal 16a at the low level.

FIG. 12 shows the states of the delayed discontinuity condition signal 17a, the property signals 13a, 14a, and 15a, and the discontinuity condition signal 16a which correspond to an original-picture portion including an isolated dot. In FIG. 12, the property signals 13a and 15a remain low in level while the property signal 14a assumes the high level for the 2-pixel term. Thus, the discontinuity monitor circuit 16 decides that a same discontinuity does not recur but an isolated dot exists. In this case, the discontinuity monitor circuit 16 holds the discontinuity condition signal 16a at the low level.

FIG. 13 shows the states of the delayed discontinuity condition signal 17a, the property signals 13a, 14a, and 15a, and the discontinuity condition signal 16a which correspond to a fixed-luminance background area in an original picture. In FIG. 13, the property signals 13a, 14a, and 15a remain low in level. Thus, the discontinuity monitor circuit 16 decides a discontinuity to be absent. In this case, the discontinuity monitor circuit 16 holds the discontinuity condition signal 16a at the low level.

It should be noted that the waveform of the discontinuity condition signal 16a shown in each of FIGS. 7-13 is of a delay corrected version.

The discontinuity monitor circuit 16 uses, for example, a microcomputer or a similar device programmed to implement the previously-mentioned operation steps. Another example of the discontinuity monitor circuit 16 is designed as follows. The discontinuity monitor circuit 16 includes four serial-in parallel-out shift registers through which the property signals 13a, 14a, and 15a and the delayed discontinuity condition signal 17a are propagated respectively. The discontinuity monitor circuit 16 further includes a first memory, a second memory, a first comparator, a second comparator, and an OR circuit. The first memory stores sixteen pixel-corresponding signal segments in a first predetermined pattern corresponding to a set of the waveforms of the property signals 13a, 14a, and 15a and the delayed discontinuity condition signal 17a in FIG. 8. The second memory stores sixteen pixel-corresponding signal segments in a second predetermined pattern corresponding to a set of the waveforms of the property signals 13a, 14a, and 15a and the delayed discontinuity condition signal 17a in FIG. 10. Each of the first and second comparator receives the output signals from the four shift registers as an indication of an input signal pattern which is formed by the last four pixel-corresponding segments of the property signal 13a, the last four pixel-corresponding segments of the property signal 14a, the last four pixel-corresponding segments of the property signal 15a, and the last four pixel-corresponding segments of the delayed discontinuity condition signal 17a. The first comparator receives the sixteen pixel-corresponding signal segments from the first memory as an indication of a first reference pattern corresponding to the waveform set in FIG. 8. The first comparator compares the input signal pattern and the first reference pattern. When the input signal pattern and the first reference pattern are the same, the first comparator outputs a high-level signal to a first input terminal of the OR circuit. Otherwise, the first comparator outputs a low-level signal to the first input terminal of the OR circuit. The second comparator receives the sixteen pixel-corresponding signal segments from the second memory as an indication of a second reference pattern corresponding to the waveform set in FIG. 10. The second comparator compares the input signal pattern and the second reference pattern. When the input signal pattern and the second reference pattern are the same, the second comparator outputs a high-level signal to a second input terminal of the OR circuit. Otherwise, the second comparator outputs a low-level signal to the second input terminal of the OR circuit. The OR circuit generates the discontinuity condition signal 16a in response to the output signals from the first and second comparators, and feeds the generated discontinuity condition signal 16a to the 1H delay circuit 17 and the resolution conversion circuit 19.

The resolution conversion circuit 19 subjects the output digital signal from the delay correction circuit 18 to an interpolation-based filtering process responsive to a designated magnification, and thereby generates a conversion-result digital signal 103 representing a conversion-result picture. The resolution conversion circuit 19 outputs the conversion-result digital signal 103. The conversion-result digital signal 103 is also referred to as the output digital signal 103.

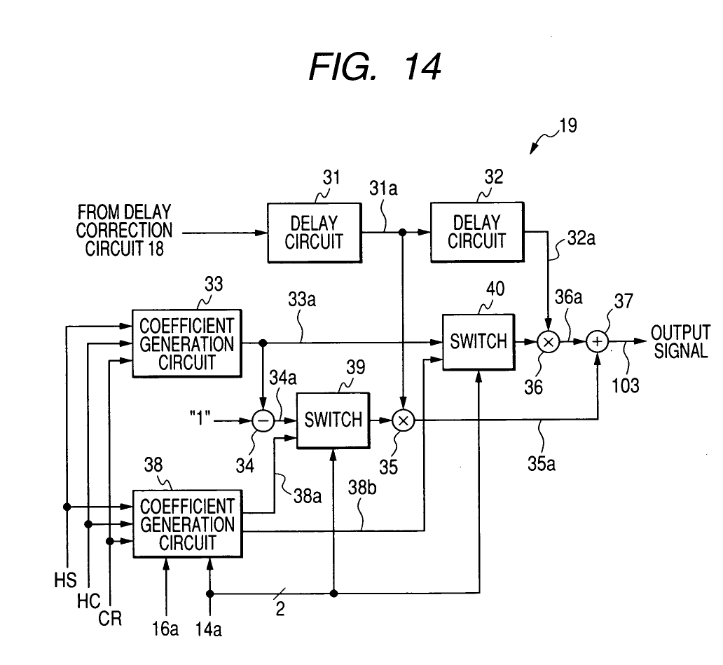

With reference to FIG. 14, the resolution conversion circuit 19 includes delay circuits 31 and 32, a coefficient generation circuit 33, a subtracter 34, multipliers 35 and 36, an adder 27, a coefficient generation circuit 38, and switches 39 and 40.

The input side of the delay circuit 31 is exposed to the output digital signal from the delay correction circuit 18. The output side of the delay circuit 31 is connected to the input side of the delay circuit 32 and a first input terminal of the multiplier 35. The output side of the delay circuit 32 is connected to a first input terminal of the multiplier 36. The coefficient generation circuits 33 and 38 receive a horizontal sync signal HS, a horizontal clock signal HC, and a parameter signal CR representing the designated magnification. The parameter signal CR is generated by, for example, an operation unit which can be actuated by a user. The designated magnification can be decided in accordance with user's request inputted via the operation unit. The coefficient generation circuit 38 further receives the property signal 14a and the discontinuity condition signal 16a from the waveform monitor 14 (see FIG. 1) and the discontinuity monitor circuit 16 (see FIG. 1). The resolution conversion circuit 19 includes a delay correction circuit (not shown) which matches the timing of the discontinuity condition signal 16a with that of the property signal 14a for a periodically-updated pixel of interest.

The output terminal of the coefficient generation circuit 33 is connected to a first input terminal of the subtracter 34 and a first input terminal of the switch 40. A second input terminal of the subtracter 34 is exposed to a fixed signal representing a coefficient of “1” which is produced by a signal generator (not shown). The output terminal of the subtracter 34 is connected to a first input terminal of the switch 39. The coefficient generation circuit 38 has first and second output terminals. The first output terminal of the coefficient generation circuit 38 is connected to a second input terminal of the switch 39. The second output terminal of the coefficient generation circuit 38 is connected to a second input terminal of the switch 40. The output terminal of the switch 39 is connected to a second input terminal of the multiplier 35. The output terminal of the multiplier 35 is connected to a first input terminal of the adder 37. The output terminal of the switch 40 is connected to a second input terminal of the multiplier 36. The output terminal of the multiplier 36 is connected to a second input terminal of the adder 37. The adder 37 outputs the conversion-result digital signal 103. The switches 39 and 40 have respective control terminals exposed to the property signal 14a fed from the waveform monitor 14 (see FIG. 1).

The delay circuit 31 defers the output digital signal from the delay correction circuit 18 by a time corresponding to one pixel to get a first delayed digital signal 31a. The delay circuit 31 feeds the first delayed digital signal 31a to the delay circuit 32 and the multiplier 35. The delay circuit 32 defers the first delayed digital signal 31a by a time corresponding to one pixel to get a second delayed digital signal 32a. The delay circuit 32 feeds the second delayed digital signal 32a to the multiplier 36. The first delayed signal 31a and the second delayed signal 32a represent two periodically-updated pixels which neighbor each other as viewed in a horizontal direction with respect to a frame represented by the output digital signal from the delay correction circuit 18.

The coefficient generation circuit 33 produces a signal 33a representative of a variable interpolation coefficient for a periodically-updated pixel of interest in response to the designated magnification indicated by the parameter signal CR. The coefficient generation circuit 33 feeds the interpolation coefficient signal 33a to the subtracter 34 and the switch 40 at a timing synchronized with the horizontal clock signal HC. Operation of the coefficient generation circuit 33 responds to the horizontal sync signal HS. The device 34 subtracts the interpolation coefficient represented by the signal 33a from a coefficient of “1”, and generates a signal 34a indicating an interpolation coefficient equal to the subtraction result. The subtracter 34 outputs the interpolation coefficient signal 34a to the switch 39 at a timing synchronized with the horizontal clock signal HC.

The coefficient generation circuit 38 produces signals 38a and 38b representative of respective coefficients in response to the parameter signal CR, the property signal 14a, and the discontinuity condition signal 16a. The coefficient generation circuit 38 outputs the coefficient signals 38a and 38b to the switches 39 and 40 respectively at a timing synchronized with the horizontal clock signal HC. Operation of the coefficient generation circuit 38 responds to the horizontal sync signal HS. A combination of the coefficients represented by the output signals 38a and 38b from the coefficient generation circuit 38 can be changed between a first state and a second state. In the first state, the coefficients represented by the signals 38a and 38b are “1” and “0” respectively. In the second state, the coefficients represented by the signals 38a and 38b are “0” and “1” respectively. A timing of change from the first state to the second state, and a timing of change from the second state to the first state are varied in accordance with the designated magnification indicated by the parameter signal CR. The discontinuity condition signal 16a determines which of the first and second states is selected. Normally, the first state is selected when the discontinuity condition signal 16a assumes the high level. Otherwise, the second state is selected or either the first state or the second state may be selected. The change between the first state and the second state also depends on the property signal 14a.

The coefficient generation circuit 33 uses, for example, a microcomputer or a similar device programmed to generate and output the interpolation coefficient signal 33a in response to the horizontal clock signal HC, the horizontal sync signal HS, and the parameter signal CR. The coefficient generation circuit 38 uses, for example, a microcomputer or a similar device programmed to generate and output the coefficient signals 38a and 38b in response to the horizontal clock signal HC, the horizontal sync signal HS, the parameter signal CR, the property signal 14a, and the discontinuity condition signal 16a.

The switch 39 selects one from the interpolation coefficient signal 34a and the coefficient signal 38a in response to the property signal 14a. Specifically, the switch 39 selects the interpolation coefficient signal 34a when the property signal 14a assumes the low level. The switch 39 selects the coefficient signal 38a when the property signal 14a assumes the high level. The switch 39 passes the selected signal to the multiplier 35.

The switch 40 selects one from the interpolation coefficient signal 33a and the coefficient signal 38b in response to the property signal 14a. Specifically, the switch 40 selects the interpolation coefficient signal 33a when the property signal 14a assumes the low level. The switch 40 selects the coefficient signal 38b when the property signal 14a assumes the high level. The switch 40 passes the selected signal to the multiplier 36.

In the case where the property signal 14a assumes the low level, the switches 39 and 40 transmit the interpolation coefficient signals 34a and 33a to the multipliers 35 and 36 respectively. The device 35 multiplies the level (the luminance level) represented by the first delayed digital signal 31a and the interpolation coefficient represented by the signal 34a to get an interpolation digital signal 35a. The multiplier 35 feeds the interpolation digital signal 35a to the adder 37. The device 36 multiplies the level (the luminance level) represented by the second delayed digital signal 32a and the interpolation coefficient represented by the signal 33a to get an interpolation digital signal 36a. The multiplier 36 feeds the interpolation digital signal 36a to the adder 37. The device 37 adds the levels represented by the interpolation digital signals 35a and 36a, and generates the conversion-result digital signal 103 in accordance with the result of the addition. Thus, in the case where the property signal 14a assumes the low level, the resolution conversion circuit 19 subjects the output digital signal from the delay correction circuit 18 to a linear interpolation process or an interpolation-based filtering process to get the conversion-result digital signal 103.

Generally, the linear interpolation process generates a pixel represented by the conversion-result digital signal 103 from two neighboring pixels represented by the input digital signal 101. The conversion-result pixel is temporally located at a position between the time positions of the two original pixels. In other words, one of the original pixels precedes the conversion-result pixel while the other follows the conversion-result pixel.

In the case where the property signal 14a assumes the high level, the switches 39 and 40 transmit the coefficient signals 38a and 38b to the multipliers 35 and 36 respectively. The device 35 multiplies the level represented by the first delayed digital signal 31a and the coefficient represented by the signal 38a to get a multiplication-result digital signal 35a. The multiplier 35 feeds the multiplication-result digital signal 35a to the adder 37. The device 36 multiplies the level represented by the second delayed digital signal 32a and the coefficient represented by the signal 38b to get a multiplication-result digital signal 36a. The multiplier 36 feeds the multiplication-result digital signal 36a to the adder 37. The device 37 adds the levels represented by the multiplication-result digital signals 35a and 36a, and generates the conversion-result digital signal 103 in accordance with the result of the addition. When a combination of the coefficients represented by the signals 38a and 38b is in the first state, the multiplication-result digital signal 35a is the same as the first delayed digital signal 31a and the multiplication-result digital signal 36a is “0”. Thus, the first delayed digital signal 31a is directly used as the conversion-result digital signal 103. In other words, a conversion-result pixel in question is assigned the signal level (the luminance level) corresponding to a pixel represented by the first delayed digital signal 31a, that is, an original pixel at a time position after the time position of the conversion-result pixel in question. When a combination of the coefficients represented by the signals 38a and 38b is in the second state, the multiplication-result digital signal 36a is the same as the second delayed digital signal 32a and the multiplication-result digital signal 35a is “0”. Thus, the second delayed digital signal 32a is directly used as the conversion-result digital signal 103. In other words, a conversion-result pixel in question is assigned the signal level corresponding to a pixel represented by the second delayed digital signal 32a, that is, an original pixel at a time position before the time position of the conversion-result pixel in question. Accordingly, in the case where the property signal 14a assumes the high level, nonlinear interpolation or nonlinear-interpolation-based filtering is implemented.

Operation of the apparatus in FIG. 1 can be changed among different modes including a mode corresponding to a pixel-number reduction or a picture reduction with a magnification factor of 4/5.

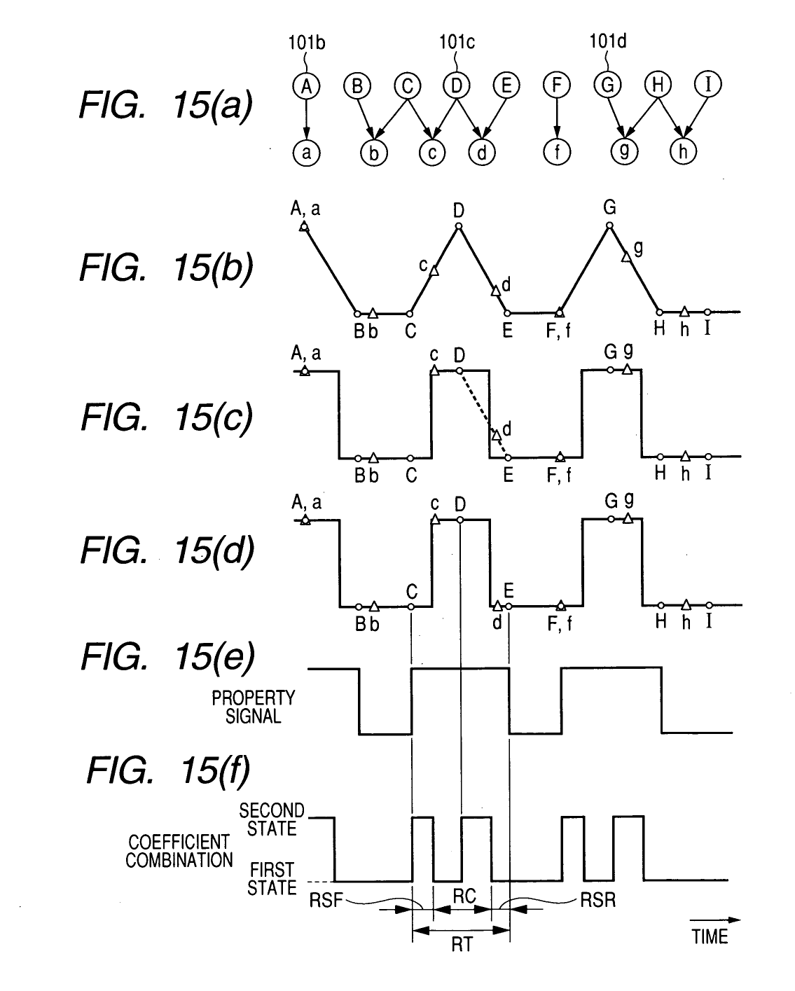

With reference to a portion (a) of FIG. 15, the apparatus of FIG. 1 which is operating in the 4/5 picture reduction mode converts a sequence of pixel-corresponding pieces A-I of the input digital signal 101 into a sequence of pixel-corresponding pieces “a”-“d” and “f”-“h” of the output digital signal (the conversion-result digital signal) 103. In the portion (a) of FIG. 15, reference characters “101b”, “101c”, and “101d” denote waveform portions represented by the pixel-corresponding pieces A, D, and G of the input digital signal 101, respectively. While the signal level represented by the input digital signal 101 is not discontinuously changing so that linear interpolation continues to be implemented, the relation among the signal levels of the original data pieces A-I and the signal levels of the conversion-result data pieces “a”-“d” and “f”-“h” is as follows. The conversion-result data piece “a” is assigned the signal level (the luminance level) represented by the original data piece A. The signal level of the conversion-result data piece “b” is decided by linear interpolation responsive to the signal levels of the original data pieces B and C. The signal level of the conversion-result data piece “c” is decided by linear interpolation responsive to the signal levels of the original data pieces C and D. For example, the signal level of the conversion-result data piece “c” is equal to 0.5 times the signal level of the original data piece C plus 0.5 times the signal level of the original data piece D. The signal level of the conversion-result data piece “d” is decided by linear interpolation responsive to the signal levels of the original data pieces D and E. For example, the signal level of the conversion-result data piece “d” is equal to 0.25 times the signal level of the original data piece D plus 0.75 times the signal level of the original data piece E. The conversion-result data piece “f” is assigned the signal level represented by the original data piece F. The signal level of the conversion-result data piece “g” is decided by linear interpolation responsive to the signal levels of the original data pieces G and H. The signal level of the conversion-result data piece “h” is decided by linear interpolation responsive to the signal levels of the original data pieces H and I.

In a portion (b) of FIG. 15, small circles denote an example of the signal levels of the original data pieces A-I, and the waveform portions 101b, 101c, and 101d represented by the original data pieces A, D, and G are local signal-level maximums while a waveform portion represented by the original data piece E assumes a bottom signal level. Small triangles in the portion (b) of FIG. 15 denote the signal levels of the conversion-result data pieces “a”-“d” and “f”-“h” which are generated in the case where the resolution conversion circuit 19 is replaced with conventional one utilizing linear interpolation. In this case, the signal level of the conversion-result data piece “c” is equal to 0.5 times the signal level of the original data piece “D”. The signal level of the conversion-result data piece “d” is equal to 0.25 times the signal level of the original data piece “D”.

In a portion (c) of FIG. 15, small circles denote the example of the signal levels of the original data pieces A-I. Small triangles therein denote the signal levels of the conversion-result data pieces “a”-“d” and “f”-“h” which are generated by the prior-art apparatus in Japanese patent application publication number P2001-274987A. In this case, the conversion-result data pieces “a”, “c”, and “g” are assigned the signal levels of the original data pieces A, D, and G corresponding to the local signal-level maximums 101b, 101c, and 101d respectively. On the other hand, the conversion-result data piece “d” is assigned an interpolation-caused signal level intermediate between the signal levels of the original data pieces D and E. As a result, a pulse-like waveform represented by the conversion-resultant data pieces which corresponds to the local signal-level maximum (the isolated point) 101c has a blunt rear edge or a blunt trailing edge.

In a portion (d) of FIG. 15, small circles denote the example of the signal levels of the original data pieces A-I. Small triangles therein denote the signal levels of the conversion-result data pieces “a”-“d” and “f”-“h” which are generated by the apparatus of FIG. 1.

As shown in a portion (e) of FIG. 15, the state of the property signal 14a changes in response to the sequence of the original data pieces A-I. As shown in a portion (f) of FIG. 15, a combination of the coefficients represented by the output signals 38a and 38b from the coefficient generation circuit 38 alternates between the first state and the second state in a pattern depending on the waveform of the property signal 14a. As understood from the portions (a), (e), and (f) of FIG. 15, the property signal 14a assumes the high level and a combination of the coefficients is in its first state for the conversion-result data piece “c”. Therefore, the signal level of the original data piece C is multiplied by “0” and the signal level of the original data piece D is directly used as the signal level of the conversion-result data piece “c”. Similarly, the property signal 14a assumes the high level and a combination of the coefficients is in its first state for the conversion-result data piece “d”. Therefore, the signal level of the original data piece D is multiplied by “0” and the signal level of the original data piece E is directly used as the signal level of the conversion-result data piece “d”. The original data piece E represents the bottom signal level. Thus, as shown in the portion (d) of FIG. 15, a pulse-like waveform represented by the conversion-resultant data pieces which corresponds to the local signal-level maximum (the isolated point) 101c has a sharp rear edge or a sharp trailing edge.

With reference to the portions (d), (e), and (f) of FIG. 15, there is a time region RT of twice the 1-pixel interval during which the property signal 14a remains high in level so that nonlinear interpolation is performed instead of linear interpolation. This time region RT is called the nonlinear-interpolation region RT. The nonlinear-interpolation region RT is centered at a time point corresponding to an original pixel (an original data piece) at which the signal level represented by the input digital signal 101 is concluded to be discontinuously changing. The nonlinear-interpolation region RT consists of a front region RSF, a central region RC, and a rear region RSR. The front region RSF precedes the central region RC. The rear region RSR follows the central region RC. The central region RC contains a time point corresponding to the original pixel at which the signal level represented by the input digital signal 101 is concluded to be discontinuously changing. When a time point corresponding to a conversion-result pixel (a conversion-result data piece) in question exists in the central region RC, the signal level of the original pixel at which the signal level represented by the input digital signal 101 is concluded to be discontinuously changing is used as the signal level of the conversion-result pixel in question. When a time point corresponding to a conversion-result pixel (a conversion-result data piece) in question exists in the front region RSF, the signal level of an original pixel at a time point in the front region RSF is used as the signal level of the conversion-result pixel in question. When a time point corresponding to a conversion-result pixel (a conversion-result data piece) in question exists in the rear region RSR, the signal level of an original pixel at a time point in the rear region RSR is used as the signal level of the conversion-result pixel in question.

It is preferable that the width of the central region RC depends on the designated magnification indicated by the parameter signal CR. This design prevents isolated points from being omitted from the conversion-result picture even when the designated magnification is changed.

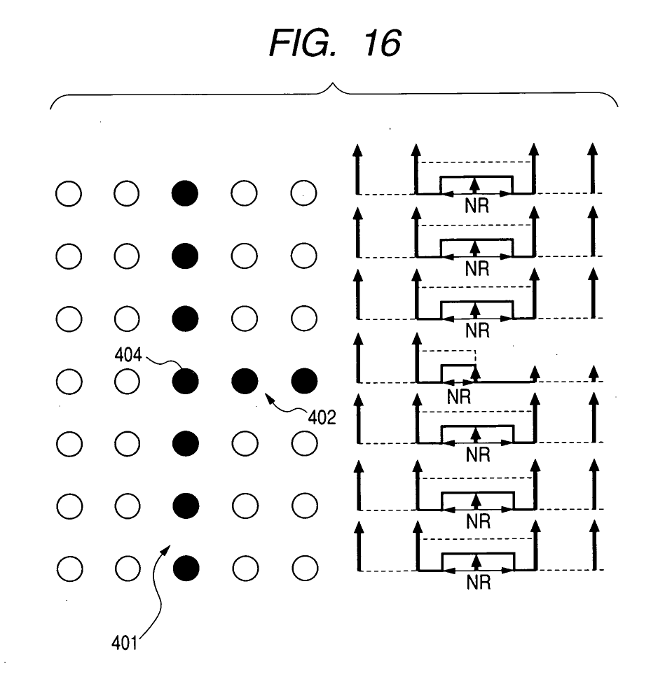

The left-hand portion of FIG. 16 shows an array of pixels constituting a portion of an original picture which has the left-hand half of a black letter “H” on a white background. In FIG. 16, black circles denote black pixels while white circles denote white pixels. The letter “H” is composed of a left-hand vertical line segment 401, a horizontal line segment 402 (partially shown in FIG. 16), and a right-hand vertical line segment (not shown in FIG. 16).

The right-hand portion of FIG. 16 shows the waveforms of the property signal 14a which correspond to the horizontal rows of pixels in the left-hand portion of FIG. 16 respectively. The waveforms of the property signal 14a are denoted by the broken lines. The right-hand portion of FIG. 16 further shows nonlinear-interpolation ranges NR related with the high-level terms in the waveforms of the property signal 14a respectively. The non-interpolation ranges NR are denoted by the solid lines. In the right-hand portion of FIG. 16, the longer upward arrows indicate the white pixels while the shorter upward arrows indicate the black pixels. Regarding each of the nonlinear-interpolation ranges NR, the luminance level at the original black pixel is used as the luminance level at a conversion-result pixel provided that the conversion-result pixel exits in the nonlinear-interpolation range NR.

For a picture portion including the connection 404 between the left-hand vertical line segment 401 and the horizontal line segment 402 of the letter “H”, the discontinuity condition signal 16a assumes a high level (see FIG. 8). The high-level discontinuity condition signal 16a causes a nonlinear-interpolation range NR extending leftward of the original black pixel. Therefore, a conversion-result pixel immediately leftward of the original black pixel at the connection 404 between the left-hand vertical line segment 401 and the horizontal line segment 402 of the letter “H” is assigned the luminance level of the foregoing original black pixel rather than the luminance level of the adjacent original white pixel. Thus, all conversion-result pixels in a vertical line immediately leftward of the left-hand vertical line segment 401 of the letter “H” are assigned the luminance levels of the original black pixels. As a result, the conversion-result picture is prevented from being distorted at a position corresponding to the connection 404 between the left-hand vertical line segment 401 and the horizontal line segment 402 of the letter “H”.

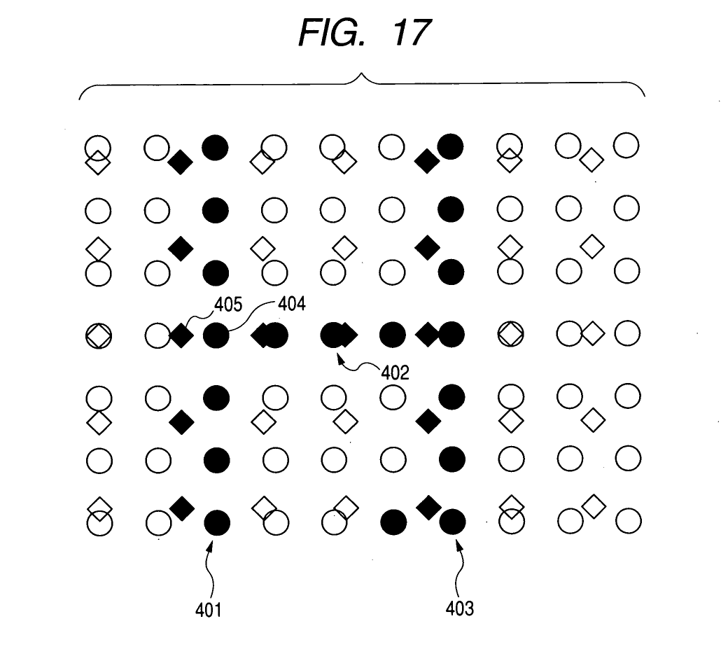

FIG. 17 shows an array of pixels constituting a portion of an original picture (a picture represented by the input digital signal 101) having a black letter “H” on a white background, and an array of pixels constituting a portion of a corresponding conversion-result picture (a picture represented by the conversion-result digital signal 103). In FIG. 17, black circles denote original black pixels while white circles denote original white pixels. Black rhombuses denote conversion-result black pixels while white rhombuses denote conversion-result white pixels. As shown in FIG. 17, a conversion-result pixel 405 immediately leftward of the original black pixel at the connection 404 between the left-hand vertical line segment 401 and the horizontal line segment 402 of the letter “H” is assigned the luminance level of the foregoing original black pixel. This operation step is caused by the high-level discontinuity condition signal 16a. As shown in FIG. 17, all conversion-result pixels in a vertical line immediately leftward of the left-hand vertical line segment 401 of the letter “H” are therefore assigned the luminance levels of the original black pixels. Consequently, the conversion-result picture is prevented from being distorted at a position corresponding to the connection 404 between the left-hand vertical line segment 401 and the horizontal line segment 402 of the letter “H”.

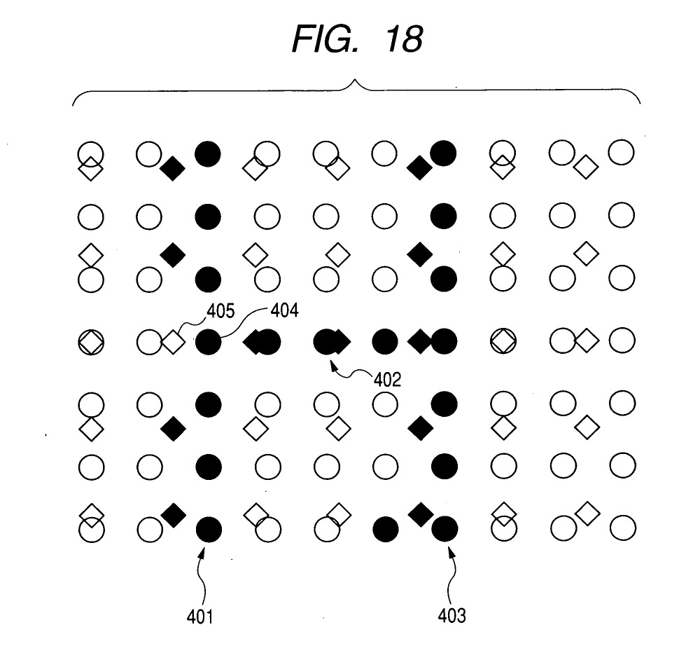

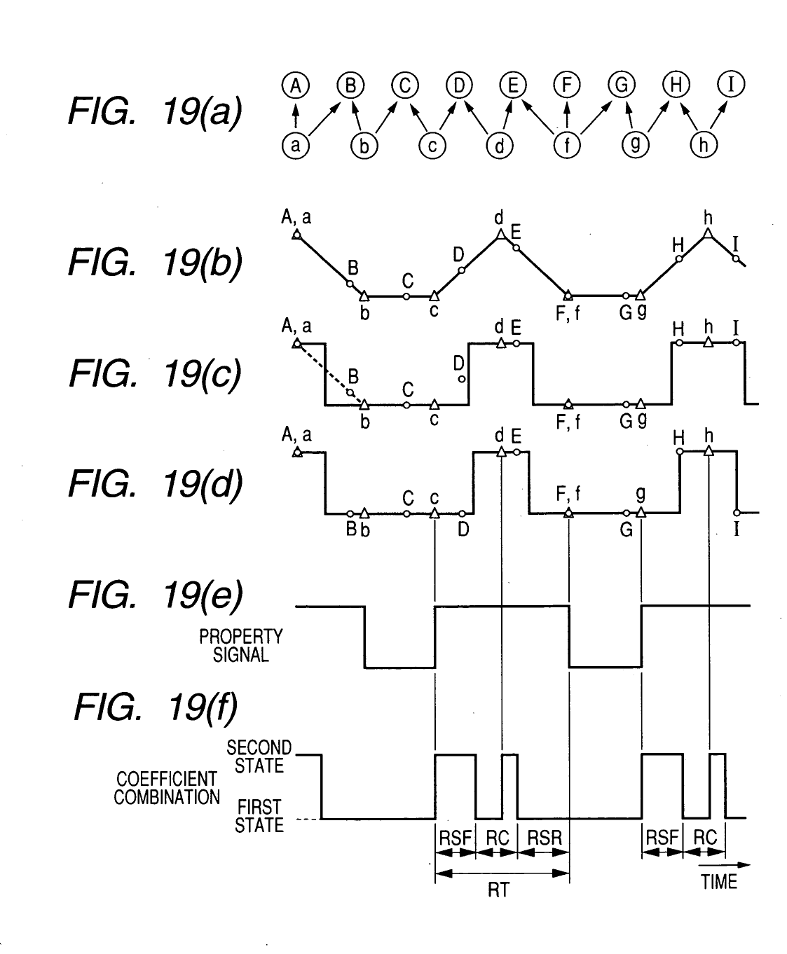

If the high-level discontinuity condition signal 16a was absent, the conversion-result pixel 405 immediately leftward of the original black pixel at the connection 404 between the left-hand vertical line segment 401 and the horizontal line segment 402 of the letter “H” might be assigned the luminance level of the adjacent white pixel as shown in FIG. 18. In this case, the conversion-result picture might be distorted at a position corresponding to the connection 404 between the left-hand vertical line segment 401 and the horizontal line segment 402 of the letter “H”.

The resolution conversion circuit 19 is of a picture reduction type. Alternatively, the resolution conversion circuit 19 may be of a picture enlargement type. In this case, the resolution conversion circuit 19 acts to enlarge an original picture or increase the number of pixels constituting one frame. The resolution conversion circuit 19 of the picture enlargement type has a structure similar to that shown in FIG. 14.

The resolution conversion circuit 19 in FIG. 14 can be used as the picture reduction type and also the picture enlargement type on a selective basis.

Operation of the apparatus in FIG. 1 which includes the resolution conversion circuit 19 of the picture enlargement type can be changed among different modes including a mode corresponding to a pixel-number increase or a picture enlargement with a magnification factor of 5/4.

With reference to a portion (a) of FIG. 19, the apparatus of FIG. 1 which is operating in the 5/4 picture enlargement mode converts a sequence of pixel-corresponding pieces “a”-“d” and “f”-“h” of the input digital signal 101 into a sequence of pixel-corresponding pieces A-I of the output digital signal (the conversion-result digital signal) 103. While the signal level represented by the input digital signal 101 is not discontinuously changing so that linear interpolation continues to be implemented, the relation among the signal levels of the original data pieces “a”-“d” and “f”-“h” and the signal levels of the conversion-result data pieces A-I is as follows. The conversion-result data piece A is assigned the signal level (the luminance level) represented by the original data piece “a”. The signal level of the conversion-result data piece B is decided by linear interpolation responsive to the signal levels of the original data pieces “a” and “b”. The signal level of the conversion-result data piece C is decided by linear interpolation responsive to the signal levels of the original data pieces “b” and “c”. The signal level of the conversion-result data piece D is decided by linear interpolation responsive to the signal levels of the original data pieces “c” and “d”. The conversion-result data piece E is decided by linear interpolation responsive to the signal levels of the original data pieces “d” and “f”. The conversion-result data piece F is assigned the signal level represented by the original data piece “f”. The signal level of the conversion-result data piece G is decided by linear interpolation responsive to the signal levels of the original data pieces “f” and “g”. The signal level of the conversion-result data piece H is decided by linear interpolation responsive to the signal levels of the original data pieces “g” and “h”.

In a portion (b) of FIG. 19, small triangles denote an example of the signal levels of the original data pieces “a”-“d” and “f”-“h” among which the original data pieces “d” and “h” correspond to local signal-level maximums (isolated points). Small circles in the portion (b) of FIG. 19 denote the signal levels of the conversion-result data pieces A-I which are generated in the case where the resolution conversion circuit 19 is replaced with conventional one utilizing linear interpolation.

In a portion (c) of FIG. 19, small triangles denote the example of the signal levels of the original data pieces “a”-“d” and “f”-“h”. Small circles therein denote the signal levels of the conversion-result data pieces A-I which are generated by the prior-art apparatus in Japanese patent application publication number P2001-274987A. In this case, the isolated point “h” in the original picture is changed into two successive high-level pixels represented by the conversion-result data pieces H and I. Thus, there occurs an irregularity in luminance concerning the isolated point.

In a portion (d) of FIG. 19, small triangles denote the example of the signal levels of the original data pieces “a”-“d” and “f”-“h”. Small circles therein denote the signal levels of the conversion-result data pieces A-I which are generated by the apparatus of FIG. 1.

As shown in a portion (e) of FIG. 19, the state of the property signal 14a changes in response to the sequence of the original data pieces “a”-“d” and “f”-“h”. As shown in a portion (f) of FIG. 19, a combination of the coefficients represented by the output signals 38a and 38b from the coefficient generation circuit 38 alternates between the first state and the second state in a pattern depending on the property signal 14a. As understood from the portions (a), (e), and (f) of FIG. 19, the property signal 14a assumes the high level and a combination of the coefficients is in its first state for the conversion-result data piece B. Therefore, the signal level of the original data piece “a” is multiplied by “0” and the signal level of the original data piece “b” is directly used as the signal level of the conversion-result data piece B. Thus, the conversion-result pixel B is assigned the signal level of the original pixel “b” at a time position after the time position of the conversion-result pixel B. The property signal 14a assumes the high level and a combination of the coefficients is in its second state for the conversion-result data piece D. Therefore, the signal level of the original data piece “d” is multiplied by “0” and the signal level of the original data piece “c” is directly used as the signal level of the conversion-result data piece D. Thus, the conversion-result pixel D is assigned the signal level of the original pixel “c” at a time position before the time position of the conversion-result pixel D. Similarly, the property signal 14a assumes the high level and a combination of the coefficients is in its second state for the conversion-result data piece E. Therefore, the signal level of the original data piece “f” is multiplied by “0” and the signal level of the original data piece “d” is directly used as the signal level of the conversion-result data piece E. Thus, the conversion-result pixel E is assigned the signal level of the original pixel “d” at a time position before the time position of the conversion-result pixel E. The property signal 14a assumes the high level and a combination of the coefficients is in its first state for the conversion-result data piece H. Therefore, the signal level of the original data piece “g” is multiplied by “0” and the signal level of the original data piece “h” is directly used as the signal level of the conversion-result data piece H. Thus, the conversion-result pixel H is assigned the signal level of the original pixel “h” at a time position after the time position of the conversion-result pixel H. Similarly, the property signal 14a assumes the high level and a combination of the coefficients is in its first state for the conversion-result data piece I. Therefore, the signal level of the original data piece “h” is multiplied by “0” and the signal level of the next data piece is directly used as the signal level of the conversion-result data piece I. Thus, the conversion-result pixel I is assigned the signal level of the original pixel at a time position after the time position of the conversion-result pixel I.

With reference to the portions (d), (e), and (f) of FIG. 19, there is a time region (a non-interpolation region) RT of twice the inter-pixel interval during which the property signal 14a remains high in level so that nonlinear interpolation is performed instead of linear interpolation. The nonlinear-interpolation region RT is centered at a time point corresponding to an original pixel (an original data piece) at which the signal level represented by the input digital signal 101 is concluded to be discontinuously changing. The nonlinear-interpolation region RT consists of a front region RSF, a central region RC, and a rear region RSR. The front region RSF precedes the central region RC. The rear region RSR follows the central region RC. The central region RC contains a time point corresponding to the original pixel at which the signal level represented by the input digital signal 101 is concluded to be discontinuously changing. When a time point corresponding to a conversion-result pixel (a conversion-result data piece) in question exists in the central region RC, the signal level of the original pixel at which the signal level represented by the input digital signal 101 is concluded to be discontinuously changing is used as the signal level of the conversion-result pixel in question. When a time point corresponding to a conversion-result pixel (a conversion-result data piece) in question exists in the front region RSF, the signal level of an original pixel at a time point in the front region RSF is used as the signal level of the conversion-result pixel in question. When a time point corresponding to a conversion-result pixel (a conversion-result data piece) in question exists in the rear region RSR, the signal level of an original pixel at a time point in the rear region RSR is used as the signal level of the conversion-result pixel in question.

As shown in the portion (d) of FIG. 19, the isolated point “h” in the original picture is changed into a single high-level pixel represented by the conversion-result data piece H and forming an isolated point also. Accordingly, an irregularity in luminance can be prevented from occurring in the conversion-result picture. It is preferable that the width of the central region RC depends on the designated magnification indicated by the parameter signal CR. This design prevents the occurrence of a luminance irregularity even when the designated magnification is changed.

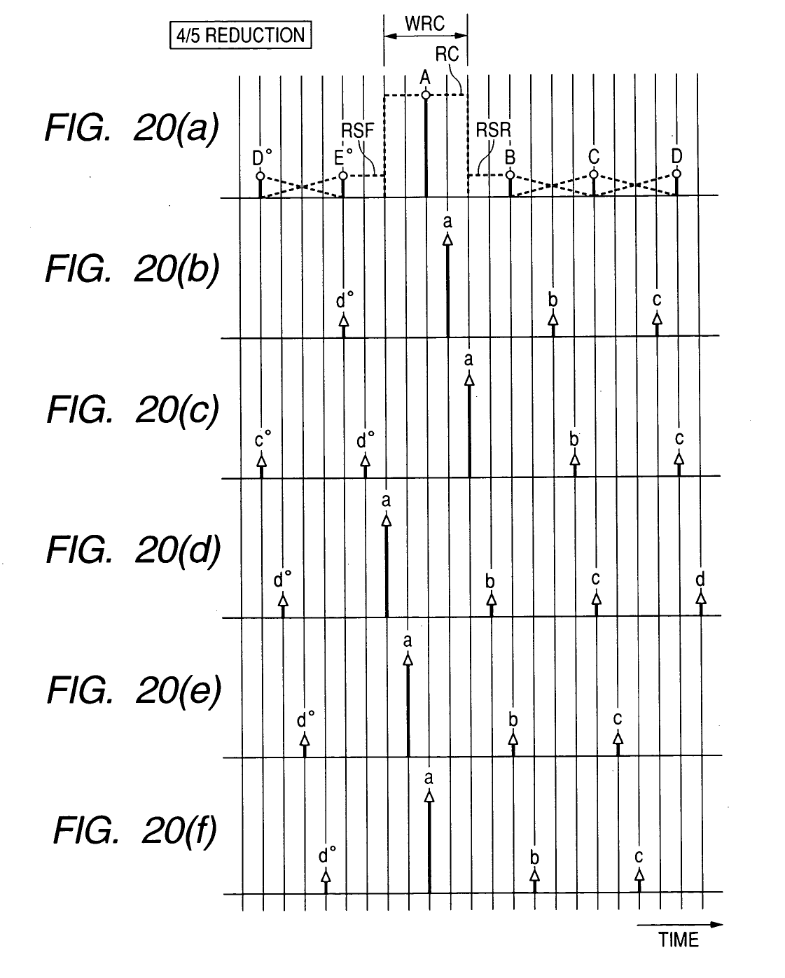

FIG. 20 has a portion (a) showing an example of a sequence of pixel-corresponding data pieces D°, E°, A, B, C, and D of the input digital signal 101. In FIG. 20, the vertical parallel lines denote reference timings of a clock period (the period of a clock signal used in image processing) or reference timings of an integral multiple of the clock period. The pixels represented by the original data pieces D°, E°, A, B, C, and D are located at respective time positions equal to ones selected from these reference timings. The interval between two neighboring reference timings (two vertical parallel lines) in FIG. 20 is referred to as the clock width. The original data piece A represents a high-level pixel corresponding to an isolated point in an original picture. Accordingly, there is a central region RC centered at the time position of the original pixel (the original data piece) A. In addition, there are a front region RSF and a rear region RSR preceding and following the central region RC respectively. During the central region RC, the front region RSF, and the rear region RSR, nonlinear interpolation is performed instead of linear interpolation. On the other hand, during other time regions, linear interpolation is implemented. In the portion (a) of FIG. 20, the crossing broken lines denote the linear-interpolation-implemented time regions.

In the portion (a) of FIG. 20, the time interval between two neighboring original pixels is equal to 4 times the clock width. Preferably, the width WRC of the central region RC is equal to or slightly greater than 4 times the clock width. The width of the front region RSF is equal to or slightly smaller than twice the clock width. The width of the rear region RSR is equal to or slightly smaller than twice the clock width. In this case, it is possible to prevent an isolated point in an original picture from being omitted from a conversion-result picture.

The resolution conversion circuit 19 implements interpolation with an interpolation phase which can be changed among different values including first to fifth values. The apparatus of FIG. 1 which is operating in the 4/5 picture reduction mode changes the sequence of the original data pieces D°, E°, A, B, C, and D in the portion (a) of FIG. 20 into a sequence of pixel-corresponding data pieces “d°”, “a”, “b”, and “c” of the conversion-result digital signal (the output digital signal) 103.

When the interpolation phase is equal to the first value, the conversion-result pixels (the conversion-result data pieces) “d°”, “a”, “b”, and “c” are located at time positions as shown in a portion (b) of FIG. 20. In this case, the conversion-result data piece “d°” is assigned the signal level of the original data piece E°. The conversion-result data piece “a” is assigned the signal level of the original data piece A. The signal level of the conversion-result data piece “b” is decided by linear interpolation responsive to the signal levels of the original data pieces B and C. The signal level of the conversion-result data piece “c” is decided by linear interpolation responsive to the signal levels of the original data pieces C and D.

When the interpolation phase is equal to the second value, the conversion-result pixels (the conversion-result data pieces) “d°”, “a”, “b”, and “c” are located at time positions as shown in a portion (c) of FIG. 20. In this case, the conversion-result data piece “d°” is assigned the signal level of the original data piece E°. The conversion-result data piece “a” is assigned the signal level of the original data piece A. The signal level of the conversion-result data piece “b” is decided by linear interpolation responsive to the signal levels of the original data pieces B and C. The conversion-result data piece “c” is assigned the signal level of the original data piece D.

When the interpolation phase is equal to the third value, the conversion-result pixels (the conversion-result data pieces) “d°”, “a”, “b”, and “c” are located at time positions as shown in a portion (d) of FIG. 20. In this case, the signal level of the conversion-result data piece “d°” is decided by linear interpolation responsive to the signal levels of the original data pieces D° and E°. The conversion-result data piece “a” is assigned the signal level of the original data piece A. The conversion-result data piece “b” is assigned the signal level of the original data piece B. The conversion-result data piece “c” is assigned the signal level of the original data piece C.

When the interpolation phase is equal to the fourth value, the conversion-result pixels (the conversion-result data pieces) “d°”, “a”, “b”, and “c” are located at time positions as shown in a portion (e) of FIG. 20. In this case, the signal level of the conversion-result data piece “d°” is decided by linear interpolation responsive to the signal levels of the original data pieces D° and E°. The conversion-result data piece “a” is assigned the signal level of the original data piece A. The conversion-result data piece “b” is assigned the signal level of the original data piece B. The signal level of the conversion-result data piece “c” is decided by linear interpolation responsive to the signal levels of the original data pieces C and D.

When the interpolation phase is equal to the fifth value, the conversion-result pixels (the conversion-result data pieces) “d°”, “a”, “b”, and “c” are located at time positions as shown in a portion (f) of FIG. 20. In this case, the signal level of the conversion-result data piece “d°” is decided by linear interpolation responsive to the signal levels of the original data pieces D° and E°. The conversion-result data piece “a” is assigned the signal level of the original data piece A. The signal level of the conversion-result data piece “b” is decided by linear interpolation responsive to the signal levels of the original data pieces B and C. The signal level of the conversion-result data piece “c” is decided by linear interpolation responsive to the signal levels of the original data pieces C and D.

As shown in FIG. 20, the isolated point represented by the original data piece A is prevented from being omitted from the conversion-result picture when the interpolation phase is equal to any one of the first to fifth values. In the case where the conversion-result data piece “a” is located at a time point on the boundary between the front region RSF and the central region RC or the boundary between the central region RC and the rear region RSR, the conversion-result data piece is assigned the signal level of the original data piece A at a time point contained in the central region RC (see the portions (c) and (d) of FIG. 20).

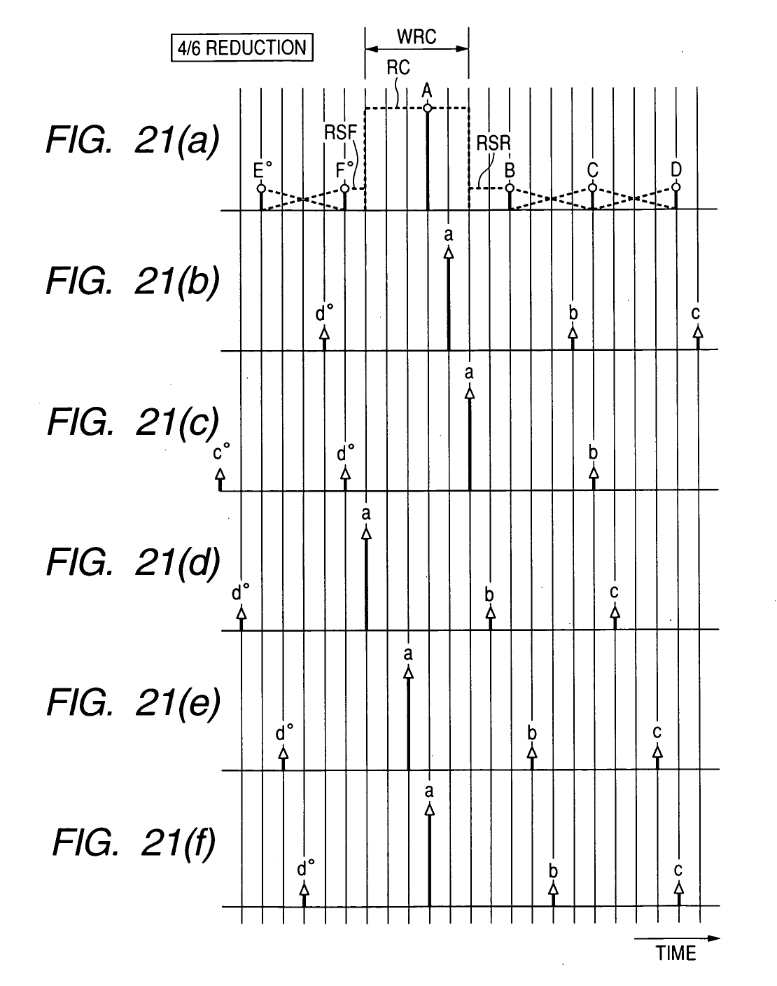

FIG. 21 has a portion (a) showing an example of a sequence of pixel-corresponding data pieces E°, F°, A, B, C, and D of the input digital signal 101. The vertical parallel lines in FIG. 21 are similar in meaning to those in FIG. 20. The pixels represented by the original data pieces E°, F°, A, B, C, and D are located at respective time positions equal to ones selected from reference timings. The original data piece A represents a high-level pixel corresponding to an isolated point in an original picture. Accordingly, there is a central region RC covering a time point of the original pixel (the original data piece) A. In addition, there are a front region RSF and a rear region RSR preceding and following the central region RC respectively. The crossing broken lines in the portion (a) of FIG. 21 are similar in meaning to those in the portion (a) of FIG. 20.

In the portion (a) of FIG. 21, the time interval between two neighboring original pixels is equal to 4 times the clock width. Preferably, the width WRC of the central region RC is equal to or slightly greater than 5 times the clock width. The width of the front region RSF is equal to or slightly smaller than the clock width. The width of the rear region RSR is equal to or slightly smaller than twice the clock width. In this case, it is possible to prevent an isolated point in an original picture from being omitted from a conversion-result picture.

The resolution conversion circuit 19 implements interpolation with an interpolation phase which can be changed among different values including first to fifth values. The apparatus of FIG. 1 which is operating in a 4/6 picture reduction mode changes the sequence of the original data pieces E°, F°, A, B, C, and D in the portion (a) of FIG. 21 into a sequence of pixel-corresponding data pieces “d°”, “a”, “b”, and “c” of the conversion-result digital signal (the output digital signal) 103.

When the interpolation phase is equal to the first value, the conversion-result pixels (the conversion-result data pieces) “d°”, “a”, “b”, and “c” are located at time positions as shown in a portion (b) of FIG. 21. In this case, the signal level of the conversion-result data piece “d°” is decided by linear interpolation responsive to the signal levels of the original data pieces E° and F°. The conversion-result data piece “a” is assigned the signal level of the original data piece A. The signal level of the conversion-result data piece “b” is decided by linear interpolation responsive to the signal levels of the original data pieces B and C. The signal level of the conversion-result data piece “c” is decided by linear interpolation responsive to the signal levels of the original data piece D and the next original data piece E (not shown).

When the interpolation phase is equal to the second value, the conversion-result pixels (the conversion-result data pieces) “c°”, “d°”, “a”, and “b” are located at time positions as shown in a portion (c) of FIG. 21. In this case, the signal level of the conversion-result data piece “c°” is decided by linear interpolation responsive to the signal levels of the original data pieces D° and E° (D° not shown). The conversion-result data piece “d°” is assigned the signal level of the original data piece F°. The conversion-result data piece “a” is assigned the signal level of the original data piece A. The conversion-result data piece “b” is assigned the signal level of the original data piece C.

When the interpolation phase is equal to the third value, the conversion-result pixels (the conversion-result data pieces) “d°”, “a”, “b”, and “c” are located at time positions as shown in a portion (d) of FIG. 21. In this case, the signal level of the conversion-result data piece “d°” is decided by linear interpolation responsive to the signal levels of the original data pieces D° and E° (D° not shown). The conversion-result data piece “a” is assigned the signal level of the original data piece A. The conversion-result data piece “b” is assigned the signal level of the original data piece B. The signal level of the conversion-result data piece “c” is decided by linear interpolation responsive to the signal levels of the original data pieces C and D.

When the interpolation phase is equal to the fourth value, the conversion-result pixels (the conversion-result data pieces) “d°”, “a”, “b”, and “c” are located at time positions as shown in a portion (e) of FIG. 21. In this case, the signal level of the conversion-result data piece “d°” is decided by linear interpolation responsive to the signal levels of the original data pieces E° and F°. The conversion-result data piece “a” is assigned the signal level of the original data piece A. The signal level of the conversion-result data piece “b” is decided by linear interpolation responsive to the signal levels of the original data pieces B and C. The signal level of the conversion-result data piece “c” is decided by linear interpolation responsive to the signal levels of the original data pieces C and D.

When the interpolation phase is equal to the fifth value, the conversion-result pixels (the conversion-result data pieces) “d°”, “a”, “b”, and “c” are located at time positions as shown in a portion (f) of FIG. 21. In this case, the signal level of the conversion-result data piece “d°” is decided by linear interpolation responsive to the signal levels of the original data pieces E° and F°. The conversion-result data piece “a” is assigned the signal level of the original data piece A. The signal level of the conversion-result data piece “b” is decided by linear interpolation responsive to the signal levels of the original data pieces B and C. The conversion-result data piece “c” is assigned the signal level of the original data piece D.

As shown in FIG. 21, the isolated point represented by the original data piece A is prevented from being omitted from the conversion-result picture when the interpolation phase is equal to any one of the first to fifth values. There is another interpolation phase value between the third value (the portion (d) of FIG. 21) and the fourth value (the portion (e) of FIG. 21). Also, at this interpolation phase value, the isolated point represented by the original data piece A is prevented from being omitted from the conversion-result picture.

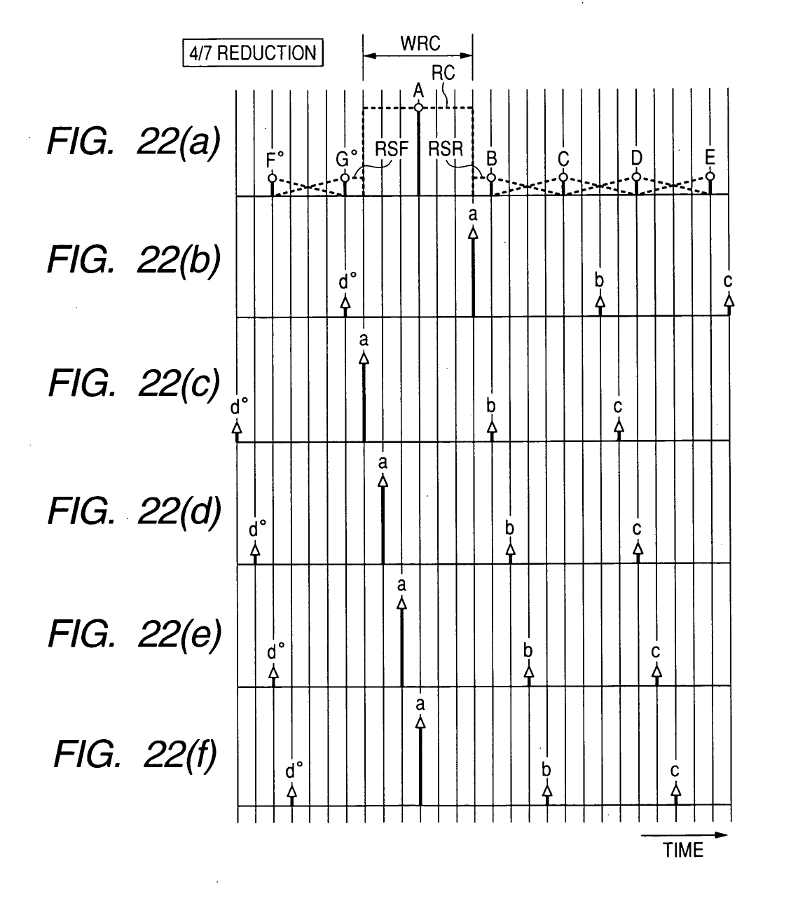

FIG. 22 has a portion (a) showing an example of a sequence of pixel-corresponding data pieces F°, G°, A, B, C, D, and E of the input digital signal 101. The vertical parallel lines in FIG. 22 are similar in meaning to those in FIG. 20. The pixels represented by the original data pieces F°, G°, A, B, C, D, and E are located at respective time positions equal to ones selected from reference timings. The original data piece A represents a high-level pixel corresponding to an isolated point in an original picture. Accordingly, there is a central region RC covering a time point of the original pixel (the original data piece) A. In addition, there are a front region RSF and a rear region RSR preceding and following the central region RC respectively. The crossing broken lines in the portion (a) of FIG. 22 are similar in meaning to those in the portion (a) of FIG. 20.

In the portion (a) of FIG. 22, the time interval between two neighboring original pixels is equal to 4 times the clock width. Preferably, the width WRC of the central region RC is equal to or slightly greater than 6 times the clock width. The width of the front region RSF is equal to or slightly smaller than the clock width. The width of the rear region RSR is equal to or slightly smaller than the clock width. In this case, it is possible to prevent an isolated point in an original picture from being omitted from a conversion-result picture.

The resolution conversion circuit 19 implements interpolation with an interpolation phase which can be changed among different values including first to fifth values. The apparatus of FIG. 1 which is operating in a 4/7 picture reduction mode changes the sequence of the original data pieces F°, G°, A, B, C, D, and E in the portion (a) of FIG. 22 into a sequence of pixel-corresponding data pieces “d°”, “a”, “b”, and “c” of the conversion-result digital signal (the output digital signal) 103.

When the interpolation phase is equal to the first value, the conversion-result pixels (the conversion-result data pieces) “d°”, “a”, “b”, and “c” are located at time positions as shown in a portion (b) of FIG. 22. In this case, the conversion-result data piece “d°” is assigned the signal level of the original data piece G°. The conversion-result data piece “a” is assigned the signal level of the original data piece A. The signal level of the conversion-result data piece “b” is decided by linear interpolation responsive to the signal levels of the original data pieces C and D. The signal level of the conversion-result data piece “c” is decided by linear interpolation responsive to the signal levels of the original data pieces E and F (F not shown).

When the interpolation phase is equal to the second value, the conversion-result pixels (the conversion-result data pieces) “d°”, “a”, “b”, and “c” are located at time positions as shown in a portion (c) of FIG. 22. In this case, the signal level of the conversion-result data piece “d°” is decided by linear interpolation responsive to the signal levels of the original data pieces E° and F° (E° not shown). The conversion-result data piece “a” is assigned the signal level of the original data piece A. The conversion-result data piece “b” is assigned the signal level of the original data piece B. The signal level of the conversion-result data piece “c” is decided by linear interpolation responsive to the signal levels of the original data pieces C and D.

When the interpolation phase is equal to the third value, the conversion-result pixels (the conversion-result data pieces) “d°”, “a”, “b”, and “c” are located at time positions as shown in a portion (d) of FIG. 22. In this case, the signal level of the conversion-result data piece “d°” is decided by linear interpolation responsive to the signal levels of the original data pieces E° and F° (E° not shown). The conversion-result data piece “a” is assigned the signal level of the original data piece A. The signal level of the conversion-result data piece “b” is decided by linear interpolation responsive to the signal levels of the original data pieces B and C. The conversion-result data piece “c” is assigned the signal level of the original data piece D.

When the interpolation phase is equal to the fourth value, the conversion-result pixels (the conversion-result data pieces) “d°”, “a”, “b”, and “c” are located at time positions as shown in a portion (e) of FIG. 22. In this case, the conversion-result data piece “d°” is assigned the signal level of the original data piece F°. The conversion-result data piece “a” is assigned the signal level of the original data piece A. The signal level of the conversion-result data piece “b” is decided by linear interpolation responsive to the signal levels of the original data pieces B and C. The signal level of the conversion-result data piece “c” is decided by linear interpolation responsive to the signal levels of the original data pieces D and E.

When the interpolation phase is equal to the fifth value, the conversion-result pixels (the conversion-result data pieces) “d°”, “a”, “b”, and “c” are located at time positions as shown in a portion (f) of FIG. 22. In this case, the signal level of the conversion-result data piece “d°” is decided by linear interpolation responsive to the signal levels of the original data pieces F° and G°. The conversion-result data piece “a” is assigned the signal level of the original data piece A. The signal level of the conversion-result data piece “b” is decided by linear interpolation responsive to the signal levels of the original data pieces B and C. The signal level of the conversion-result data piece “c” is decided by linear interpolation responsive to the signal levels of the original data pieces D and E.

As shown in FIG. 22, the isolated point represented by the original data piece A is prevented from being omitted from the conversion-result picture when the interpolation phase is equal to any one of the first to fifth values. There are two other interpolation phase values. The first other interpolation phase value corresponds to that shown in the portion (b) of FIG. 21. The second other interpolation phase value corresponds to that shown in the portion (c) of FIG. 21. Also, at the first and second other interpolation phase values, the isolated point represented by the original data piece A is prevented from being omitted from the conversion-result picture.

In the case where the apparatus of FIG. 1 is operating in one selected from picture reduction modes, it is preferable to increase the width WRC of the central region RC as the designated magnification decreases. This design prevents isolated points in an original picture from being omitted from a conversion-result picture regardless of the designated magnification.

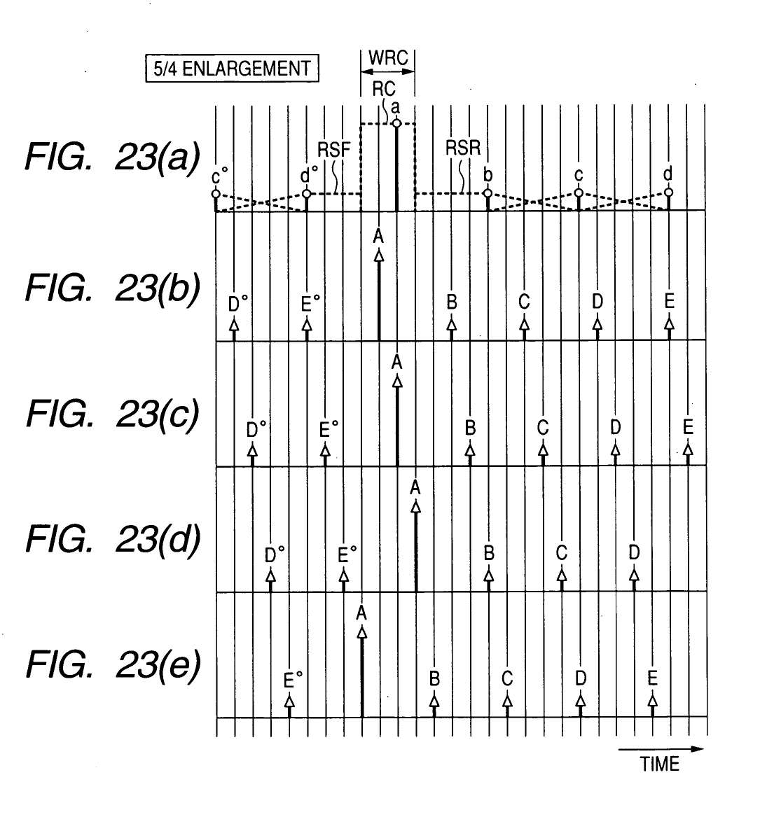

FIG. 23 has a portion (a) showing an example of a sequence of pixel-corresponding data pieces “c°”, “d°”, “a”, “b”, “c”, and “d” of the input digital signal 101. The vertical parallel lines in FIG. 23 are similar in meaning to those in FIG. 20. The pixels represented by the original data pieces “c°”, “d°”, “a”, “b”, “c”, and “d” are located at respective time positions equal to ones selected from reference timings. The original data piece “a” represents a high-level pixel corresponding to an isolated point in an original picture. Accordingly, there is a central region RC covering a time point of the original pixel (the original data piece) “a”. In addition, there are a front region RSF and a rear region RSR preceding and following the central region RC respectively. The crossing broken lines in the portion (a) of FIG. 23 are similar in meaning to those in the portion (a) of FIG. 20.

In the portion (a) of FIG. 23, the time interval between two neighboring original pixels is equal to 5 times the clock width. Preferably, the width WRC of the central region RC is equal to or slightly greater than 3 times the clock width. The width of the front region RSF is equal to or slightly smaller than 3 times the clock width. The width of the rear region RSR is equal to or slightly smaller than 4 times the clock width. In this case, it is possible to prevent the occurrence of a luminance irregularity related to an isolated point in a conversion-result picture.

The resolution conversion circuit 19 implements interpolation with an interpolation phase which can be changed among different values including first to fourth values. The apparatus of FIG. 1 which is operating in the 5/4 picture enlargement mode changes the sequence of the original data pieces “c°”, “d°”, “b”, “c”, and “d” in the portion (a) of FIG. 23 into a sequence of pixel-corresponding data pieces D°, E°, A, B, C, D, and E of the conversion-result digital signal (the output digital signal) 103.

When the interpolation phase is equal to the first value, the conversion-result pixels (the conversion-result data pieces) D°, E°, A, B, C, D, and E are located at time positions as shown in a portion (b) of FIG. 23. In this case, the signal level of the conversion-result data piece D° is decided by linear interpolation responsive to the signal levels of the original data pieces “c°” and “d°”. The conversion-result data piece E° is assigned the signal level of the original data piece “d°”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”. The signal level of the conversion-result data piece D is decided by linear interpolation responsive to the signal levels of the original data pieces “c” and “d”.

When the interpolation phase is equal to the second value, the conversion-result pixels (the conversion-result data pieces) D°, E°, A, B, C, D, and E are located at time positions as shown in a portion (c) of FIG. 23. In this case, the signal level of the conversion-result data piece D° is decided by linear interpolation responsive to the signal levels of the original data pieces “c°” and “d°”. The conversion-result data piece E° is assigned the signal level of the original data piece “d°”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”. The signal level of the conversion-result data piece D is decided by linear interpolation responsive to the signal levels of the original data pieces “c” and “d”.

When the interpolation phase is equal to the third value, the conversion-result pixels (the conversion-result data pieces) D°, E°, A, B, C, and D are located at time positions as shown in a portion (d) of FIG. 23. In this case, the signal level of the conversion-result data piece D° is decided by linear interpolation responsive to the signal levels of the original data pieces “c°” and “d°”. The conversion-result data piece E° is assigned the signal level of the original data piece “d°”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”. The signal level of the conversion-result data piece D is decided by linear interpolation responsive to the signal levels of the original data pieces “c” and “d”.

When the interpolation phase is equal to the fourth value, the conversion-result pixels (the conversion-result data pieces) E°, A, B, C, D, and E are located at time positions as shown in a portion (e) of FIG. 23. In this case, the signal level of the conversion-result data piece E° is decided by linear interpolation responsive to the signal levels of the original data pieces “c°” and “d°”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”. The conversion-result data piece D is assigned the signal level of the original data piece “c”. The signal level of the conversion-result data piece E is decided by linear interpolation responsive to the signal levels of the original data pieces “c” and “d”.

As shown in FIG. 23, the isolated point represented by the original data piece “a” is correctly converted into an isolated point in the conversion-result picture when the interpolation phase is equal to any one of the first to fourth values. Therefore, it is possible to prevent a luminance irregularity from occurring in the conversion-result picture.

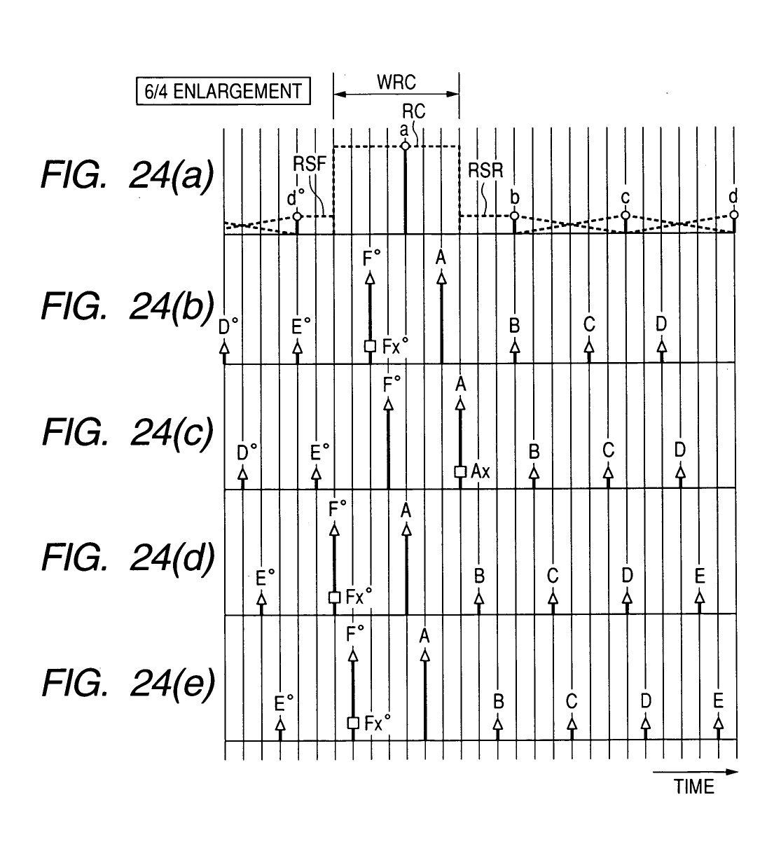

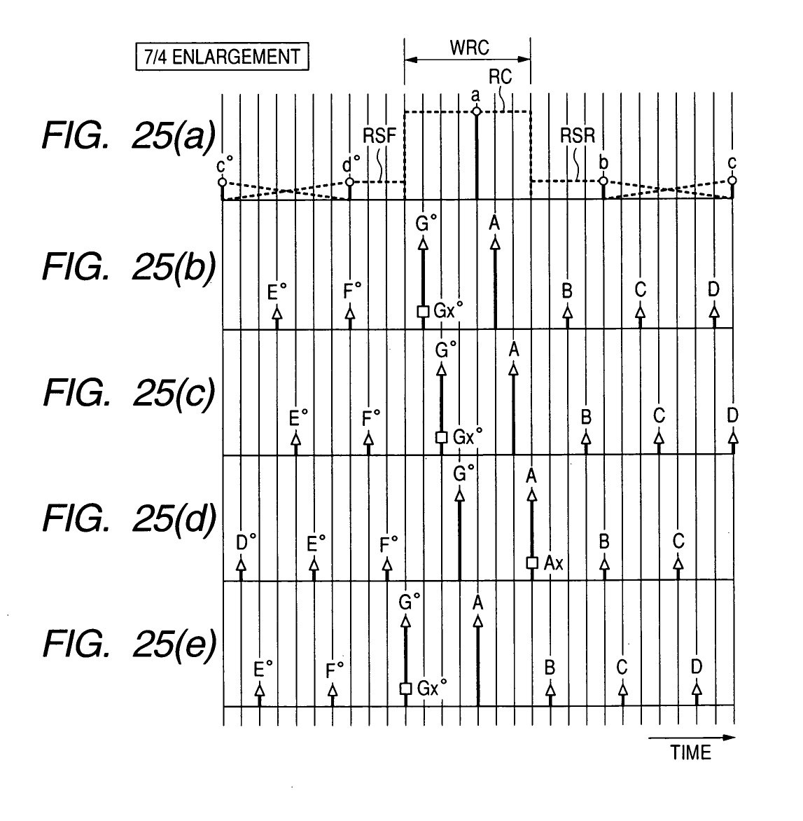

FIG. 24 has a portion (a) showing an example of a sequence of pixel-corresponding data pieces “d°”, “a”, “b”, “c”, and “d” of the input digital signal 101. The vertical parallel lines in FIG. 24 are similar in meaning to those in FIG. 20. The pixels represented by the original data pieces “d°”, “a”, “b”, “c”, and “d” are located at respective time positions equal to ones selected from reference timings. The original data piece “a” represents a high-level pixel corresponding to an isolated point in an original picture. Accordingly, there is a central region RC covering a time point of the original pixel (the original data piece) “a”. In addition, there are a front region RSF and a rear region RSR preceding and following the central region RC respectively. The crossing broken lines in the portion (a) of FIG. 24 are similar in meaning to those in the portion (a) of FIG. 20.

In the portion (a) of FIG. 24, the time interval between two neighboring original pixels is equal to 6 times the clock width. Preferably, the width WRC of the central region RC is equal to or slightly greater than 7 times the clock width. The width of the front region RSF is equal to or slightly smaller than twice the clock width. The width of the rear region RSR is equal to or slightly smaller than 3 times the clock width. In this case, it is possible to prevent the occurrence of a luminance irregularity related to an isolated point in a conversion-result picture.

The resolution conversion circuit 19 implements interpolation with an interpolation phase which can be changed among different values including first to fourth values. The apparatus of FIG. 1 which is operating in a 6/4 picture enlargement mode changes the sequence of the original data pieces “d°”, “a”, “b”, “c”, and “d” in the portion (a) of FIG. 24 into a sequence of pixel-corresponding data pieces D°, E°, F°, A, B, C, and D of the conversion-result digital signal (the output digital signal) 103.

When the interpolation phase is equal to the first value, the conversion-result pixels (the conversion-result data pieces) D°, E°, F°, A, B, C, and D are located at time positions as shown in a portion (b) of FIG. 24. In this case, the signal level of the conversion-result data piece D° is decided by linear interpolation responsive to the signal levels of the original data pieces “c°” and “d°” (c° not shown). The conversion-result data piece E° is assigned the signal level of the original data piece “d°”. The conversion-result data piece F° is assigned the signal level of the original data piece “a”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”. The signal level of the conversion-result data piece D is decided by linear interpolation responsive to the signal levels of the original data pieces “c” and “d”.

When the interpolation phase is equal to the second value, the conversion-result pixels (the conversion-result data pieces) D°, E°, F°, A, B, C, and D are located at time positions as shown in a portion (c) of FIG. 24. In this case, the signal level of the conversion-result data piece D° is decided by linear interpolation responsive to the signal levels of the original data pieces “c°” and “d°” (c° not shown). The conversion-result data piece E° is assigned the signal level of the original data piece “d°”. The conversion-result data piece F° is assigned the signal level of the original data piece “a”. The conversion-result data piece A is assigned the signal level of the original data piece “a”. The signal level of the conversion-result data piece B is decided by linear interpolation responsive to the signal levels of the original data pieces “b” and “c”. The signal level of the conversion-result data piece C is decided by linear interpolation responsive to the signal levels of the original data pieces “b” and “c”. The signal level of the conversion-result data piece D is decided by linear interpolation responsive to the signal levels of the original data pieces “c” and “d”.

When the interpolation phase is equal to the third value, the conversion-result pixels (the conversion-result data pieces) E°, F°, A, B, C, D, and E are located at time positions as shown in a portion (d) of FIG. 24. In this case, the signal level of the conversion-result data piece E° is decided by linear interpolation responsive to the signal levels of the original data pieces “c°” and “d°” (c° not shown). The conversion-result data piece F° is assigned the signal level of the original data piece “a”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”. The conversion-result data piece D is assigned the signal level of the original data piece “c”. The signal level of the conversion-result data piece E is decided by linear interpolation responsive to the signal levels of the original data pieces “c” and “d”.

When the interpolation phase is equal to the fourth value, the conversion-result pixels (the conversion-result data pieces) E°, F°, A, B, C, D, and E are located at time positions as shown in a portion (e) of FIG. 24. In this case, the signal level of the conversion-result data piece E° is decided by linear interpolation responsive to the signal levels of the original data pieces “c°” and “d°” (c° not shown). The conversion-result data piece F° is assigned the signal level of the original data piece “a”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”. The signal level of the conversion-result data piece D is decided by linear interpolation responsive to the signal levels of the original data pieces “c” and “d”. The signal level of the conversion-result data piece E is decided by linear interpolation responsive to the signal levels of the original data pieces “c” and “d”.

As shown in FIG. 24, the isolated point represented by the original data piece “a” is converted into two successive high-level pixels (F° and A) in the conversion-result picture when the interpolation phase is equal to any one of the first to fourth values. Therefore, it is possible to prevent a luminance irregularity from occurring in the conversion-result picture.

In the portions (b), (d), and (e) of FIG. 24, the conversion-result data piece F° may be assigned the signal level of the original data piece “d°”. In this case, the conversion-result data piece F° represents a signal level denoted by Fx°. In the portion (c) of FIG. 24, the conversion-result data piece A may be assigned the signal level of the original data piece “b”. In this case, the conversion-result data piece A represents a signal level denoted by Ax. According to these modified designs, only a single high-level pixel is allowed to exist in the central region RC and the isolated point represented by the original data piece “a” is correctly converted into an isolated point in the conversion-result picture when the interpolation phase is equal to any one of the first to fourth values. In the modified designs, the resolution conversion circuit 19 responds to a selection signal which is generated in accordance with user's request, and which decides whether an isolated point (an isolated high-level pixel) in an original picture is converted into two successive high-level pixels or an isolated point in a conversion-result picture.

FIG. 25 has a portion (a) showing an example of a sequence of pixel-corresponding data pieces “c°”, “d°”, “a”, “b”, and “c” of the input digital signal 101. The vertical parallel lines in FIG. 25 are similar in meaning to those in FIG. 20. The pixels represented by the original data pieces “c°”, “d°”, “a”, “b”, and “c” are located at respective time positions equal to ones selected from reference timings. The original data piece “a” represents a high-level pixel corresponding to an isolated point in an original picture. Accordingly, there is a central region RC covering a time point of the original pixel (the original data piece) “a”. In addition, there are a front region RSF and a rear region RSR preceding and following the central region RC respectively. The crossing broken lines in the portion (a) of FIG. 25 are similar in meaning to those in the portion (a) of FIG. 20.

In the portion (a) of FIG. 25, the time interval between two neighboring original pixels is equal to 7 times the clock width. Preferably, the width WRC of the central region RC is equal to or slightly greater than 7 times the clock width. The width of the front region RSF is equal to or slightly smaller than 3 times the clock width. The width of the rear region RSR is equal to or slightly smaller than 4 times the clock width. In this case, it is possible to prevent the occurrence of a luminance irregularity related to an isolated point in a conversion-result picture.

The resolution conversion circuit 19 implements interpolation with an interpolation phase which can be changed among different values including first to fourth values. The apparatus of FIG. 1 which is operating in a 7/4 picture enlargement mode changes the sequence of the original data pieces “c°”, “d°”, “a”, “b”, and “c” in the portion (a) of FIG. 25 into a sequence of pixel-corresponding data pieces E°, F°, G°, A, B, C, and D of the conversion-result digital signal (the output digital signal) 103.

When the interpolation phase is equal to the first value, the conversion-result pixels (the conversion-result data pieces) E°, F°, G°, A, B, C, and D are located at time positions as shown in a portion (b) of FIG. 25. In this case, the signal level of the conversion-result data piece E° is decided by linear interpolation responsive to the signal levels of the original data pieces “c°” and “d°”. The conversion-result data piece F° is assigned the signal level of the original data piece “d°”. The conversion-result data piece G° is assigned the signal level of the original data piece “a”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”. The signal level of the conversion-result data piece D is decided by linear interpolation responsive to the signal levels of the original data pieces “b” and “c”.

When the interpolation phase is equal to the second value, the conversion-result pixels (the conversion-result data pieces) E°, F°, G°, A, B, C, and D are located at time positions as shown in a portion (c) of FIG. 25. In this case, the signal level of the conversion-result data piece E° is decided by linear interpolation responsive to the signal levels of the original data pieces “c°” and “d°”. The conversion-result data piece F° is assigned the signal level of the original data piece “d°”. The conversion-result data piece G° is assigned the signal level of the original data piece “a”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”. The conversion-result data piece D is assigned the signal level of the original data piece “c”.

When the interpolation phase is equal to the third value, the conversion-result pixels (the conversion-result data pieces) D°, E°, F°, G°, A, B, and C are located at time positions as shown in a portion (d) of FIG. 25. In this case, the signal level of the conversion-result data piece D° is decided by linear interpolation responsive to the signal levels of the original data pieces “c°” and “d°”. The signal level of the conversion-result data piece E° is decided by linear interpolation responsive to the signal levels of the original data pieces “c°” and “d°”. The conversion-result data piece F° is assigned the signal level of the original data piece “d°”. The conversion-result data piece G° is assigned the signal level of the original data piece “a”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”.

When the interpolation phase is equal to the fourth value, the conversion-result pixels (the conversion-result data pieces) E°, F°, G°, A, B, C, and D are located at time positions as shown in a portion (e) of FIG. 25. In this case, the signal level of the conversion-result data piece E° is decided by linear interpolation responsive to the signal levels of the original data pieces “c°” and “d°”. The signal level of the conversion-result data piece F° is decided by linear interpolation responsive to the signal levels of the original data pieces “c°” and “d°”. The conversion-result data piece G° is assigned the signal level of the original data piece “a”. The conversion-result data piece A is assigned the signal level of the original data piece “a”. The conversion-result data piece B is assigned the signal level of the original data piece “b”. The signal level of the conversion-result data piece C is decided by linear interpolation responsive to the signal levels of the original data pieces “b” and “c”. The signal level of the conversion-result data piece D is decided by linear interpolation responsive to the signal levels of the original data pieces “b” and “c”.

As shown in FIG. 25, the isolated point represented by the original data piece “a” is converted into two successive high-level pixels (G° and A) in the conversion-result picture when the interpolation phase is equal to any one of the first to fourth values. Therefore, it is possible to prevent a luminance irregularity from occurring in the conversion-result picture.

In the portions (b), (c), and (e) of FIG. 25, the conversion-result data piece G° may be assigned the signal level of the original data piece “d°”. In this case, the conversion-result data piece G° represents a signal level denoted by Gx°. In the portion (d) of FIG. 25, the conversion-result data piece A may be assigned the signal level of the original data piece “b”. In this case, the conversion-result data piece A represents a signal level denoted by Ax. According to these modified designs, only a single high-level pixel is allowed to exist in the central region RC and the isolated point represented by the original data piece “a” is correctly converted into an isolated point in the conversion-result picture when the interpolation phase is equal to any one of the first to fourth values. In the modified designs, the resolution conversion circuit 19 responds to a selection signal which is generated in accordance with user's request, and which decides whether an isolated point (an isolated high-level pixel) in an original picture is converted into two successive high-level pixels or an isolated point in a conversion-result picture.

In the case where the designated magnification corresponds to a picture reduction or enlargement factor of N/M (N and M denoting positive integers), it is preferable to set the width WRC of the central region RC according to an equation as follows.
WRC=DPXL·(K·M−1)/N+α (1)
where DPXL denotes the inter-pixel interval expressed in unit of clock width; K denotes an integer; and “α” denotes a predetermined addition value equal to or greater than “0” and less than the clock width. The integer K is equal to “1” for picture reducing conversion, and is equal to the natural number to which the magnification factor N/M is rounded for picture enlarging conversion.

In the case of picture reducing conversion, the equation (1) increases the width WRC of the central region RC as the magnification factor N/M decreases, that is, as the number M increases or the number N decreases. Also in the case of picture enlarging conversion with a magnification factor N/M less than 1.5, the integer K is equal to “1” and hence the equation (1) increases the width WRC of the central region RC as the magnification factor N/M decreases, that is, as the number M increases or the number N decreases.

In the case of picture enlarging conversion with a magnification factor N/M equal to or less than 2.0, it is preferable to increase the width WRC of the central region RC as the magnification factor N/M increases.

The equation (1) uses the clock width as a reference. The clock width is equal to the period of image processing. For picture reducing conversion with a magnification factor of 4/6, the image processing period (the reference period) is equal to one fourth of the inter-pixel interval DPXL. For picture reducing conversion with a magnification factor of 2/3, the image processing period (the reference period) is equal to a half of the inter-pixel interval DPXL. The difference in reference period between picture reducing conversion with a magnification factor of 4/6 and picture reducing conversion with a magnification factor of 2/3 causes a difference in width WRC therebetween. Specifically, for picture reducing conversion with a magnification factor of 4/6, the equation (1) gives the width WRC of the central region RC as “WRC=DPXL·(5/4)+α”. For picture reducing conversion with a magnification factor of 2/3, the equation (1) gives the width WRC of the central region RC as “WRC=DPXL·(2/2)+α”. A similar relation exists between picture enlarging conversion with a magnification factor of 6/4 and picture enlarging conversion with a magnification factor of 3/2.

What is claimed is:

1. An image data processing apparatus comprising:
first means for monitoring a level of a first digital signal representative of an original picture in a first prescribed region having a first predetermined number of pixels arranged along a first direction, and deciding whether or not the monitored level changes discontinuously at a pixel of interest in the first prescribed region;
second means for monitoring a discontinuity of the first digital signal representative of the original picture in a second prescribed region having a second predetermined number of pixels arranged along a second direction perpendicular to the first direction, and generating a discontinuity condition signal representing a continuity-related condition of the monitored discontinuity;
third means for generating first data representative of a linear interpolation coefficient in response to a conversion magnification;
fourth means for generating second data representative of a nonlinear-interpolation coefficient in response to the conversion magnification and the discontinuity condition signal generated by the second means;
fifth means for selecting the first data generated by the third means as selection-result data when the first means decides that the monitored level does not change discontinuously at the pixel of interest, and selecting the second data generated by the fourth means as the selection-result data when the first means decides that the monitored level changes discontinuously at the pixel of interest; and
sixth means for subjecting the first digital signal to an interpolation-based filtering process responsive to the selection-result data generated by the fifth means to convert the first digital signal into a second digital signal representative of a conversion-result picture.

2. An image data processing apparatus as recited in claim 1, wherein the fourth means and the fifth means comprise means for using the level of the first digital signal at the pixel of interest as a level of the second digital signal at a pixel in a setting range containing a time point corresponding to the pixel of interest when the first means decides that the monitored level changes discontinuously at the pixel of interest, and means for increasing the setting range as the conversion magnification decreases in cases where the conversion magnification corresponds to picture reducing conversion.

3. An image data processing apparatus as recited in claim 1, wherein the fourth means and the fifth means comprise means for using the level of the first digital signal at the pixel of interest as a level of the second digital signal at a pixel in a setting range containing a time point corresponding to the pixel of interest when the first means decides that the monitored level changes discontinuously at the pixel of interest, and means for increasing the setting range as the conversion magnification increases in cases where the conversion magnification corresponds to picture enlarging conversion.

4. An image data processing method comprising the steps of:
monitoring a level of a first digital signal representative of an original picture in a first prescribed region having a first predetermined number of pixels arranged along a first direction, and deciding whether or not the monitored level changes discontinuously at a pixel of interest in the first prescribed region;
monitoring a discontinuity of the first digital signal representative of the original picture in a second prescribed region having a second predetermined number of pixels arranged along a second direction perpendicular to the first direction, and generating a discontinuity condition signal representing a continuity-related condition of the monitored discontinuity;
generating first data representative of a linear interpolation coefficient in response to a conversion magnification;
generating second data representative of a nonlinear-interpolation coefficient in response to the conversion magnification and the discontinuity condition signal;
selecting the first data as selection-result data when it is decided that the monitored level does not change discontinuously at the pixel of interest, and selecting the second data as the selection-result data when it is decided that the monitored level changes discontinuously at the pixel of interest; and
subjecting the first digital signal to an interpolation-based filtering process responsive to the selection-result data to convert the first digital signal into a second digital signal representative of a conversion-result picture.
